(19) United States
(12) Patent Application Publication
(10) Pub. No.: US 2026/0046808 A1
(43) Pub. Date: Feb. 12, 2026

(54) METHODS FOR SUPPORTING POSITIONING WITH MOBILE ACCESS NODES

(71) Applicant: InterDigital Patent Holdings, Inc., Wilmington, DE (US)

(72) Inventors: Jaya Rao, Montreal (CA); Fumihiro Hasegawa, Westmount (CA); Tuong Hoang, Montreal (CA); Tao Deng, New York, NY (US); Dylan Watts, Montreal (CA); Brian Martin, Farnham (GB); Moon IL Lee, Melville, NY (US); Paul Marinier, Brossard (CA); Oumer Teyeb, Montreal (CA); Kunjan Shah, London (GB)

(73) Assignee: InterDigital Patent Holdings, Inc., Wilmington, DE (US)

(21) Appl. No.: 19/099,581

(22) PCT Filed: Aug. 8, 2023
(86) PCT No.: PCT/US2023/071815

§ 371 Date: Jan. 29, 2025

Related U.S. Application Data
(60) Provisional application No. 63/395,904, filed on Aug. 8, 2022.

(51) Int. Cl. H04W 64/00; H04L 5/00; H04W 24/10; H04W 56/00; H04W 84/06

(52) U.S. Cl. CPC H04W 64/00; H04L 5/005; H04L 5/0051; H04W 24/10; H04W 56/0065; H04W 84/06

(57) ABSTRACT

A wireless transmit/receive unit (WTRU) may be configured to receive configuration information indicating a plurality of sets of associations. Each set of associations may comprise a plurality of respective time instances and a plurality of respective timing advance (TA) offsets. The WTRU may transmit an indication of at least one of a mobile network node identification or WTRU location information. The WTRU may receive an indication of a first set of associations of the plurality of sets of associations. The WTRU may transmit a first sounding reference signal (SRS) for positioning (SRSp) transmission beginning at a first time. The first time may be determined based on at least a first TA offset of the first set of associations and a respective first time instance associated with the first TA offset.

### CROSS REFERENCE TO RELATED APPLICATIONS

This application claims the benefit of U.S. Provisional Application No. 63/395,904 filed Aug. 8, 2022, the entire contents of which are incorporated herein by reference.

### BACKGROUND

In downlink positioning methods, positioning reference signals (PRSs) may be sent from multiple transmission-reception points (TRPs) to the WTRU. The WTRU may observe multiple reference signals and may measure time difference of arrival (TDoA) between a pair of PRSs. Then, the WTRU may send the measured reference signal time difference (RSTD) to the network (e.g., the location management function (LMF). In addition, the WTRU may send measured reference signal received power (RSRP) for each PRS. Based on the returned measurements, the LMF may conduct positioning of the WTRU. Additionally or alternatively, the WTRU may report RSRP for downlink (DL) angle-based positioning methods.

In uplink positioning methods, the WTRU may send a sounding reference signal (SRS) for positioning, configured by the radio resource control (RRC), to TRPs. In timing-based methods, the TRP may measure a relative time of arrival (RTOA) for received SRS and may report measured values to the LMF. The WTRU may report the RSRP for the SRS. In angle-based uplink positioning methods, the TRP may measure angles of arrival and may report to the LMF.

In uplink and downlink positioning methods, a WTRU may measure a Rx-Tx time difference between received PRS and transmitted SRS. The WTRU may report the measured Rx-Tx time difference to the LMF. The WTRU may report measured RSRP for PRS. Similarly, at TRP, a Rx-Tx difference between received SRS and transmitted PRS may be computed.

Positioning procedures for DL-PRS measurements in RRC CONNECTED allow limited level of intra-gNB mobility (within coverage areas of TRPs belonging to the same gNB) and inter-gNB mobility (for scenarios where the same PRS configuration is used by multiple gNBs). The reporting of measurements or location information to the LMF is supported via the serving gNB/cell.

### SUMMARY

A wireless transmit/receive unit (WTRU) may receive configuration information indicating a plurality of sets of associations. Each set of associations may comprise a plurality of respective time instances and a plurality of respective timing advance (TA) offsets. The WTRU may transmit an indication of at least one of a mobile network node identification or WTRU location information. The WTRU may receive an indication of a first set of associations of the plurality of sets of associations. The WTRU may transmit a first sounding reference signal (SRS) for positioning (SRSp) transmission beginning at a first time. The first time may be determined based on at least a first TA offset of the first set of associations and a first time instance associated with the first TA offset.

The first TA offset may be based on a first satellite TA offset. The WTRU may transmit the first SRSp transmission to a satellite corresponding to the mobile network node identification or the WTRU location information. The first time may be prior to the first time instance by a first TA value. The first TA value may be determined based on the first TA offset. The first TA value may be determined based on a sum of the first TA offset and a first WTRU TA offset. The first WTRU TA offset may be determined based on a first location of the WTRU. The first TA offset may be selected from the first set of associations based on a resource used for the first SRSp transmission being associated with the first time instance. The first TA offset may be selected based on an area in which the WTRU and/or the satellite is located. The configuration information may comprise a set of SRSp resources. The first SRSp transmission may be transmitted using at least one resource of the set of SRSp resources.

The WTRU may receive an indication of a second set of associations of the plurality of sets of associations. The WTRU may transmit a second SRSp transmission beginning at a second time. The second time may be determined based on at least a second TA offset of the second set of associations and a second time instance associated with the second TA offset. The second TA offset may be based on a second satellite TA offset. The second time may be prior to the second time instance by a second TA value. The second TA value may be determined based on the second TA offset. The second TA value may be determined based on a sum of the second TA offset and a second WTRU TA offset. The second WTRU TA offset may be determined based on a second location of the WTRU or the first location of the WTRU.

Methods and apparatuses are provided for supporting positioning with mobile access nodes. Methods and apparatuses are provided for supporting DL-based positioning with mobile access nodes. Methods and apparatuses are provided for supporting UL-based positioning with mobile access nodes.

A WTRU may select the SRSp configuration (e.g., SRSp resources transmission power, periodicity, repetition factor), from a preconfigured set of candidates, to use for an UL-based positioning with a mobile satellite based on determination of differential TA (e.g., difference between TA at UE and TA at reference point) and/or relative location of the WTRU with respect to the mobile satellite. A WTRU may be configured to receive configuration information from the network. The WTRU may determine the differential TA based on the configuration information. If the differential TA is less than a predetermined threshold, the WTRU may select a first SRSp configuration (e.g., SRSp with 2 repetitions). The WTRU may send an indication to the network, requesting to activate the selected first SRSp configuration. The WTRU may transmit the SRSp using resources in the first SRSp configuration, upon receiving an activation indication from network and/or upon applying the TA offset to SRSp at the associated transmission time instances. If the differential TA is greater than or equal to the predetermined threshold, the WTRU may select a second SRSp configuration (e.g., SRSp with 8 repetitions). The WTRU may send an indication to the network, requesting to activate the selection of the first SRSp configuration. The WTRU may transmit the SRSp using resources in the second SRSp config, upon receiving an activation indication from the network and/or upon applying the TA offset to the SRSp at the associated transmission time instances.

A WTRU may perform one or more measurements (e.g., such as an RSRP and/or a ToA) of PRS received from a mobile satellite based on a time difference (e.g., RSTD) calculation made with respect to a reference point on the cell/beam associated with the satellite. The WTRU may be configured to receive configuration information from the network. The WTRU may perform a first RSRP and/or a first TOA measurement(s) of a PRS received from a satellite at a first measurement time instance. If the measured RSRP is greater than or equal to an RSRP threshold and the measured TOA minus the expected TOA at a reference point is less than a RSTD threshold, the WTRU may perform second RSRP and/or TOA measurement of the PRS at a second measurement time instance and perform a third RSRP and/or TOA measurement of the PRS at the second measurement time instance using an alternate PRS configuration. If the measured RSRP is less than the RSRP threshold, the WTRU may select an alternative satellite and/or perform a second RSRP and/or TOA measurements of the PRS at the second measurement time instance using the alternat PRS configuration. The WTRU may report to LMF the first, second, and/or third RSRP and/or TOA measurement to the LMF.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example WTRU performing measurements of a positioning reference signals (PRSs) received from a mobile satellite.

FIG. 3 depicts an example determination of measurement configuration for use in measuring a PRS received from a mobile access node.

FIG. 4 depicts an example of switching from using a first satellite to a second satellite based on a switching event.

FIG. 5 depicts an example measurement configuration determination based on a relative movement of a WTRU with respect to a movement threshold.

FIG. 6 depicts an example selection of a sounding reference signal (SRS) for positioning (SRSp) configuration for uplink-based positioning with a mobile satellite.

FIG. 7 depicts an example round trip time (RTT) measurement configuration selection.

FIG. 8 depicts another example selection of a sounding reference signal (SRS) for positioning (SRSp) configuration for uplink-based positioning with a mobile satellite.

FIG. 9 depicts a flowchart for transmitting uplink SRSp with timing advances (TAs).

### DETAILED DESCRIPTION

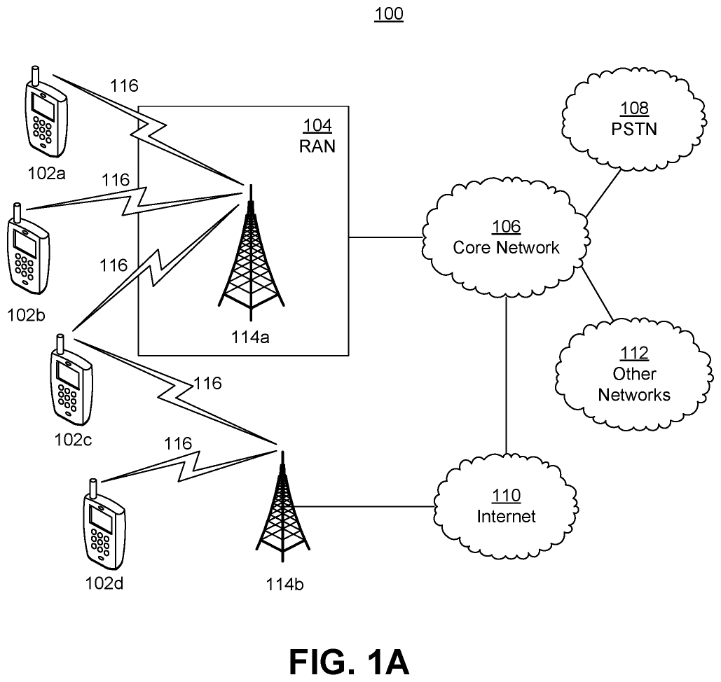

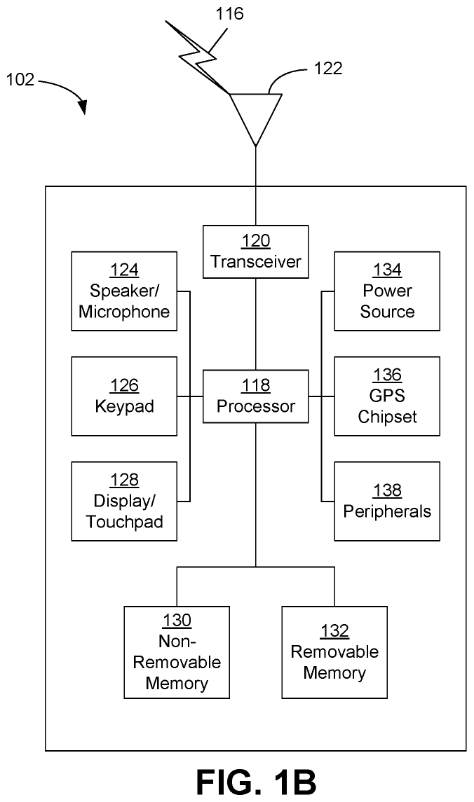

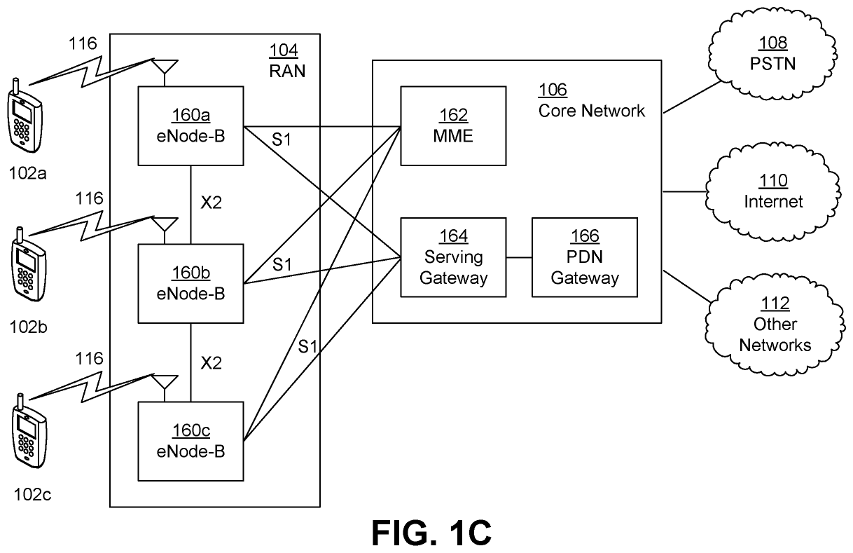

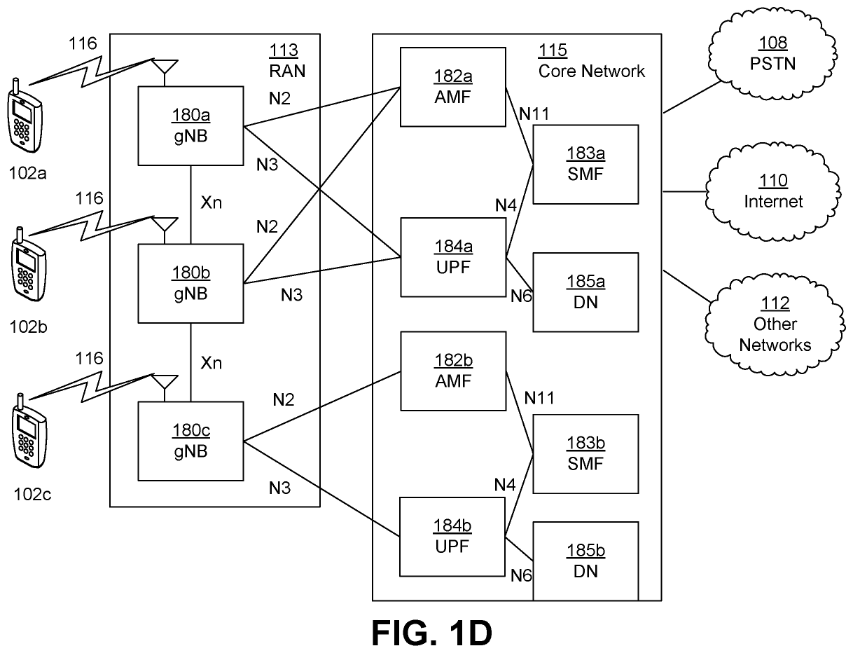

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with one or more of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in examples, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In examples, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. In examples, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. In examples, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include one or more of AMF 182a, 182b, one or more of UPF 184a, 184b, one or more Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Downlink, uplink and downlink, and uplink positioning methods may be provided. In the downlink positioning methods, positioning reference signals (PRSs) may be sent from multiple transmission-reception points (TRPs) to the WTRU. The WTRU may observe multiple reference signals and may measure time difference of arrival (TDoA) between a pair of PRSs. Then, the WTRU may send the measured reference signal time difference (RSTD) to the network (e.g., the location management function (LMF). In addition, the WTRU may send measured reference signal received power (RSRP) for each PRS. Based on the returned measurements, the LMF may conduct positioning of the WTRU. Additionally or alternatively, the WTRU may report RSRP for downlink (DL) angle-based positioning methods.

An LMF is a non-limiting example of a node or entity (e.g., network node or entity) that may be used for or to support positioning. Any other node or entity may be substituted for LMF and still be consistent with the disclosure herein.

In uplink positioning methods, the WTRU may send a sounding reference signal (SRS) for positioning, configured by the radio resource control (RRC), to TRPs. In timing-based methods, the TRP may measure a relative time of arrival (RTOA) for received SRS and may report measured values to the LMF. The WTRU may report the RSRP for the SRS. In angle-based uplink positioning methods, the TRP may measure angles of arrival and may report to the LMF.

In uplink and downlink positioning methods, a WTRU may measure a Rx-Tx time difference between received PRS and transmitted SRS. The WTRU may report the measured Rx-Tx time difference to the LMF. The WTRU may report measured RSRP for PRS. Similarly, at TRP, a Rx-Tx difference between received SRS and transmitted PRS may be computed.

A DL positioning method may refer to any positioning method that uses downlink reference signals such as PRS. The WTRU may receive multiple reference signals from a transmission point (TP) and may measure a DL RSTD and/or RSRP. Examples of DL positioning methods may include DL angle of departure (AOD) (DL-AoD) and/or DL time difference of arrival (TDOA) (DL-TDOA) positioning.

An UL positioning method may refer to any positioning method that uses uplink reference signals such as SRS for positioning. The WTRU transmits SRS to multiple RPs and the RPs measure the UL RTOA and/or RSRP. Examples of UL positioning methods are UL-TDOA or UL-AoA positioning.

A DL & UL positioning method may refer to any positioning method that uses both uplink and downlink reference signals for positioning. In examples, a WTRU may transmit a SRS to multiple TRPs and the gNB measures the Rx-Tx time difference. The gNB may measure a RSRP for the received SRS. The WTRU may measure the Rx-Tx time difference for PRS transmitted from multiple TRPs. The WTRU may measure a RSRP for the received PRS. The Rx-TX difference and/or RSRP may be measured at the WTRU and gNB may be used to compute a round trip time. Rx and Tx difference may refer to the difference between arrival time of the reference signal transmitted by the TRP and transmission time of the reference signal transmitted from the WTRU. An example of DL & UL positioning method is multi-RTT positioning.

Network as used herein may include AMF, LMF, base station, TRP, and/or gNB in NG-RAN.

Positioning procedures for DL-PRS measurements in RRC CONNECTED allow limited level of intra-gNB mobility (within coverage areas of TRPs belonging to the same gNB) and inter-gNB mobility (for scenarios where the same PRS configuration is used by multiple gNBs). The reporting of measurements or location information to the LMF is supported via the serving gNB/cell.

Mobile access node as used herein may include one or more satellites, base stations, TRPs, and/or gNBs in NG-RAN, IAB nodes, relay nodes, drones, robots, positioning reference units (PRUs) and/or WTRUs (e.g., anchor WTRU, reference WTRU). A mobile access node may be mobile (e.g., moving in some direction and/or with some speed) relative to one or more stationary or mobile WTRUs, and/or other network nodes (e.g., TRPs, gNBs).

WTRU-based and LMF-based (e.g., WTRU-assisted) positioning for RAT-dependent and RAT-independent positioning procedures may be provided. The WTRU behavior and the procedures for supporting positioning in terrestrial networks (TN) or non-terrestrial networks (NTN), including one or more steps in any given positioning procedures, not limited to reception of broadcast channels, configuration, transmission/reception of initial access messages, transmission/reception of positioning signals, measurements and reporting, which may be supported by WTRU with low latency, high reliability, high power savings and high accuracy are unknown. The procedures and signaling for positioning, including transmission and reception of capability info, assistance data, request for location information and measurement reports are supported via LTE positioning protocol (LPP). LPP procedures and signaling may be used for determining the WTRU positioning information with mobile access nodes/TRPs.

In NTN scenarios, the satellites (e.g., LEO satellites) may be highly mobile with respect to a WTRU located on the earth surface. Similarly, in industrial internet of things (IIoT) or public safety scenarios, the drones or robots may be mobile over certain trajectories. In these scenarios, as per the positioning service request/requirement (e.g., LCS request), the WTRU may be positioned with relatively high accuracy (e.g., <1 m horizontal/vertical accuracy) when at least a subset of access nodes (e.g., NTN satellites, TRPs, drones, relay nodes) are mobile.

In DL based positioning methods, the WTRU performs measurements of resources associated with DL-PRS and sends measurement reports to LMF based on assistance data provided by network. In UL-based positioning methods, the WTRU is configured with SRS for positioning (SRSp) resources via RRC signaling. The transmission of the SRSp by the WTRU is then received by different TRPs/gNBs in the network for performing positioning measurements and reporting of the measurements to the LMF and determining the WTRU location. Such positioning procedures that may allow for determining the location of WTRU with certain accuracy may be performed by WTRU and/or network each time the location of the access node with respect to WTRU changes due to using mobile access nodes.

Having to perform lengthy positioning procedures each time for sending any assistance data or initiating any positioning procedure may result in unnecessary overhead, increase in latency and loss in power efficiency. Additionally, since the WTRU may be either stationary or mobile relative to the moving satellites or TRPs, performing positioning of WTRU with mobile access nodes/satellites with high accuracy and low overhead is challenging.

In this regard, the key problem to address is: How to support positioning of WTRU efficiently and with high accuracy when one or more of the access nodes (e.g., satellites, TRPs) are mobile?

SRS for positioning as used herein may refer to an SRS signal/transmission used for positioning. Resources for SRS for positioning (SRSp) may be defined (e.g., signalled) by RRC. SRS resource set and SRS resource configured for positioning may be provided. “SRS for positioning” and/or “SRS” as used herein may include an SRS which is configured under SRS-PosResourceSet-r16 and SRS-PosResource-r16; an SRS which is configured under SRS-ResourceSet and SRS-Resource; an SRS which is not configured under SRS-PosResourceSet-r16 and SRS-PosResource-r16, an SRS which is not configured under SRS-ResourceSet and SRS-Resource; an SRS which is not associated with SRS-PosResourceSet-r16, SRS-PosResource-r16, SRS-ResourceSet, or SRS-Resource; an uplink reference signal that is associated for positioning; a DM-RS for uplink; and/or a PTRS for uplink.

SRS for positioning may be denoted as “SRSp” herein. PRS and SRS as used herein are not limited to RS used for positioning. The methods herein can be applied to or used with any DL or UL reference signals.

A positioning configuration may include a set of information related to positioning measurement and/or SRSp transmission. A positioning configuration may include one or more of a positioning method used (e.g., DL-TDOA, UL-TDOA, DL-AOD, UL-AoA, Multi-RTT), a PRS configuration, an SRSp configuration, an uplink resource (e.g., PRACH, PUSCH, PUCCH) to report the positioning measurement, one or more threshold values to determine the positioning measurement quality, and/or a positioning mode of operation (e.g., starting positioning mode of operation). A PRS resource configuration may include one or more of a PRS resource ID, a PRS sequence ID or other IDs used to generate PRS sequence, a PRS resource element offset, a PRS resource slot offset, a PRS symbol offset, a PRS QCL information, a PRS resource set ID, a list of PRS resources in the resource set, a number of PRS symbols, a muting pattern for PRS, muting parameters such as repetition factor, muting options, a PRS resource power, a periodicity of PRS transmission, a spatial direction information of PRS transmission (e.g., beam information, angles of transmission), a spatial direction information of UL RS reception (e.g., beam ID used to receive UL RS, angle of arrival), a Frequency layer ID, a TRP ID, and/or a PRS ID.

An SRSp resources configuration may include one or more of a resource ID, a Comb offset values, cyclic shift values, a start position in the frequency domain, a number of SRSp symbols, a shift in the frequency domain for SRSp, a frequency hopping pattern, a type of SRSp (e.g., aperiodic, semi-persistent, or periodic), a sequence ID used to generate SRSp or other IDs used to generate SRSp sequence, spatial relation information (e.g., indicating which reference signal (e.g., DL RS, UL RS, CSI-RS, SRS, DM-RS) or SSB (e.g., SSB ID, cell ID of the SSB) the SRSp is related to spatially), QCL information (e.g., a QCL relationship between SRSp and other reference signals or SSB), QCL type (e.g., QCL type A, QCL type B, QCL type D), a resource set ID, a list of SRSp resources in the resource set, transmission power related information, pathloss reference information which may include index for SSB, CSI-RS or PRS, a periodicity of SRSp transmission, spatial direction information of SRSp transmission (e.g., beam information, angles of transmission), spatial direction information of DL RS reception (e.g., beam ID used to receive DL RS, angle of arrival)

As the part of the configuration, the WTRU may receive information related to the cell ID, global cell ID, and/or TRP ID which is associated with PRS. For example, the TRP which transmits PRS may be identified by the TRP ID, which may belong to a cell identified by the cell ID. The WTRU may be configured with timing information such as SFN offset for PRS or SRSp transmission. The offset may prevent the WTRU from receiving overlapping PRS in the time domain.

The WTRU may obtain the parameters or configurations related to SRSp or SRS in RRC, MAC-CE, DCI or in a LPP message. Alternatively, the WTRU may obtain the parameters, configurations or thresholds (e.g., threshold for RSRP) related to SRSp or SRS in a broadcast message (e.g., SIB) or in dedicated signaling for the WTRU from the network.

SRS and SRSp may be used interchangeably herein. Mobile access node, mobile TRP/gNB, satellite, and/or NTN node may be used interchangeably herein when referring to any network node or WTRU which may be mobile with respect to a target WTRU which may be positioned. The target WTRU may be either stationary or relatively mobile with respect to a mobile access node/satellite which may be used for positioning. The target WTRU may perform PRS measurements and/or SRSp transmissions from/to the mobile access node/satellite during positioning.

In examples, as the NTN satellite/node orbits the earth, the relative position of the NTN node changes for a fixed WTRU on earth's surface. By considering the NTN node at different time instances as virtual TRPs, it may be possible to apply DL/UL-based positioning methods with some modifications.

For DL-based positioning with NTN satellites, a WTRU may measure DL signals (e.g., PRS) received from one or more mobile satellites (e.g., LEO, MEO satellites) at different time instances/occasions based on the trajectory/ephemeris data the satellites are expected to follow (e.g., NTN node orbit) and orbit speed.

For UL-based positioning, the WTRU may transmit UL signals (e.g., SRSp) that may be measured by one or more mobile satellites when triggered by events (e.g., scheduled time occasions aligned with satellites trajectory). The benefits of using mobile satellites for positioning may include improvement in measurement efficiency due to use of minimal amount of BW and/or number of TRPs/nodes for positioning, lower overhead due to minimal (per-satellite) assistance data (e.g., PRS/SRSp configurations) and improved robustness against radio environment changes (e.g., can avoid blockages, avoid NLOS paths), for example.

When performing measurements of DL signals received from a single mobile NTN node, it is important that the WTRU measures the DL signals at time instances that account for the satellite trajectory/ephemeris data, orbit speed, positioning errors, corrections/offsets, etc. This is to ensure positioning accuracy and to avoid dilution of precision (DOP) issues (e.g., NTN nodes/TRPs have not moved sufficiently between different measurement occasions). A similar issue arises for UL-based positioning where, it is important that the WTRU performs transmission of UL signals at time instances that account for the satellite trajectory/ephemeris data, orbit speed, positioning errors, corrections/offsets (e.g., TA), etc.

In examples, the WTRU and/or network may use more than one trajectories, corresponding to one or more satellites, to perform accurate measurements of time difference of arrival (TDOA) with respect to a reference time of arrival (ToA) measurement. The WTRU/NW may determine virtual TRPs based on the trajectory and speed of the satellites (e.g., for a given trajectory of a single satellite, the measurements made at 5 seconds apart may be considered as measurements from different satellites). In this case, timestamps may be used to associate the measurements, for example. The WTRU may indicate which measurement (associated with a timestamp) were used as the reference measurement, for example.

A WTRU may be provided with assistance data on a set of one or more satellites (e.g., NTN satellites) with known trajectory/ephemeris data (e.g., WTRU knows the expected locations of satellites for positioning at different time instances/occasions), for example, for supporting positioning with mobile satellites. The WTRU may also be provided with time windows, indicating the time instances and/or duration for performing positioning measurements/transmissions from/to moving satellites, for example. In examples, the WTRU may receive assistance data on a combination of trajectories of satellites with expected time of start/end of measurements for each trajectory. The WTRU may follow a sequence of time windows for measurements. The reason for this is once a satellite sink into the horizon, the WTRU may not perform measurements/transmission from/to the satellite anymore, for example. In examples, for single mobile satellite, the WTRU may perform measurements periodically with a periodicity value corresponding to measurement time window.

In examples, the WTRU may have an option to select a combination of fixed satellites (e.g., geostationary) and mobile satellites (e.g., LEO satellites) for positioning. Such selection may be made based on a configured criteria to ensure high accuracy, low latency, etc. For example, a WTRU may determine the satellites (e.g., mobile and/or geostationary) to use based on a measurement time window and an inter-measurement separation criterion. If the WTRU is unable to observe enough mobile satellites that may overlap in the time window, the WTRU may rely on multiple geostationary satellites for positioning, for example.

A WTRU may initiates positioning with mobile access nodes. In examples, a WTRU may be triggered to initiate one or more of the positioning procedures (e.g., DL-based, UL-based) using one or more access nodes (e.g., satellites, TRPs) where one or more of the access node/satellite may be mobile. The positioning of a WTRU (e.g., target WTRU) using one or more mobile nodes may be initiated based on triggering and/or reception of an LCS message. For example, an LCS client in the WTRU (e.g., for MO-LR) or network/LMF (e.g., MT-LR) may trigger a request for location info of the WTRU along with an implicit or explicit indication indicating the use of one or more mobile TRPs/satellites for positioning the WTRU. In examples, an LCS client/network may explicitly indicate to perform positioning of a WTRU with satellites/drones.

In examples, the LCS client/network may implicitly indicate the use of mobile TRPs/satellites, when available, when indicating a relaxed latency requirement for positioning, for example. Additionally or alternatively, an LCS client/network may implicitly indicate the use of mobile TRPs/satellites when providing the expected trajectory info (e.g., IDs, assistance data) of mobile TRPs/satellites and/or the scheduled location of TRP/satellite at one or more time instances, along with the LCS request for positioning the WTRU, for example.

The positioning of a WTRU (e.g., target WTRU) using one or more mobile nodes may be initiated based on reception of LPP request/indication. For example, a WTRU with an ongoing LPP session may receive an indication/configuration info to include one or more mobile TRPs/satellite in the positioning measurements when the mobile TRPs are in range of WTRU (e.g., WTRU is able to detect any SSB/PRS transmission from the mobile TRP).

In examples, the WTRU may receive an indication from network (e.g., LMF, gNB) indicating to switch to and/or initiate/activate a different positioning session (e.g., new LPP session) when some mobile TRPs/satellites are available/detectable to the WTRU. For example, such indication may be received by WTRU based on an indication/message sent by the WTRU to network informing any of the following: an initial WTRU location, initial measurements of PRS/SSB/CSI-RS, initial estimation of timing advance (TA) value, and/or detection of one or more mobile access nodes/TRPs/satellites (e.g., IDs).

The positioning of a WTRU (e.g., target WTRU) using one or more mobile nodes may be initiated by the WTRU. For example, positioning using satellites may be initiated by the WTRU when the WTRU is in coverage of any of the satellites and/or detecting the PRS transmitted by the satellite.

In examples, a WTRU preconfigured with some initial PRS configurations may use the configuration for detecting a satellite which may transmit the PRS continuously or periodically (e.g., similar to GNSS signals). The WTRU may perform initial measurements of the PRS using the preconfigured PRS configurations associated with the satellite. If the PRS measurements satisfy certain criteria/conditions (e.g., ToA/RSRP of PRS is above a threshold and/or remains above a threshold for some duration) the WTRU may report to the network the PRS measurements or location estimate of the WTRU, for example.

A WTRU may select the SRSp configuration (e.g., SRSp resources transmission power, periodicity, repetition factor), from a preconfigured set of candidates, to use for an UL-based positioning with a mobile satellite based on determination of differential TA (e.g., difference between TA at WTRU and TA at reference point) and/or relative location of the WTRU with respect to the mobile satellite. A WTRU may be configured to receive configuration information from the network. The WTRU may determine the differential TA based on the configuration information. If the differential TA is less than a predetermined threshold, the WTRU may select a first SRSp configuration (e.g., SRSp with 2 repetitions). The WTRU may send an indication to the network, requesting to activate the selected first SRSp configuration. The WTRU may transmit the SRSp using resources in the first SRSp configuration, upon receiving an activation indication from network and/or upon applying the TA offset to SRSp at the associated transmission time instances. If the differential TA is greater than or equal to the predetermined threshold, the WTRU may select a second SRSp configuration (e.g., SRSp with 8 repetitions). The WTRU may send an indication to the network, requesting to activate the selection of the first SRSp configuration. The WTRU may transmit the SRSp using resources in the second SRSp config, upon receiving an activation indication from the network and/or upon applying the TA offset to the SRSp at the associated transmission time instances.

A WTRU may send capability and/or assistance information to a network (e.g., gNB or LMF) for performing positioning measurements and/or transmissions using one or more mobile access nodes based on detection of one or more triggering events, as described herein.

The WTRU may send the capability/assistance information semi-statically before/after initializing positioning procedure (e.g., LPP session) for determining location of WTRU, for example. Additionally or alternatively, the WTRU may send capability/assistance information dynamically or on on-demand basis at any given time after initializing positioning procedure involving mobile access nodes, for example. The WTRU may send the capability/assistance information to the network in LPP messages (e.g., LPP provide capability info or LPP provide assistance info message) or AS layer signaling/messages (e.g., RRC, MAC CE, UCI, PUSCH).

The information sent by the WTRU to the network, either as capability information (e.g., via LPP capability transfer procedure, AS layer signaling/messages) or assistance information (e.g., via LPP assistance data transfer procedure, AS layer signaling/messages) may include one or more methods applied when using mobile access nodes. The one or more methods may include a capability to operate in WTRU-assisted mode and/or WTRU-based mode when using mobile access nodes. For example, the WTRU may indicate the ability to estimate location of WTRU, when operating in WTRU-based mode, when at least a subset of the one or more access nodes are mobile.

The one or more methods may include a type of nodes. For example, the WTRU may indicate the one or more identifiers/info associated with the mobile access nodes (e.g., satellites, NTN nodes, TRPs/gNBs, PRUs) which may be used for performing positioning measurements and/or transmissions, for example.

The one or more methods may include Techniques and/or algorithms. For example, the WTRU may indicate the identifiers/info on the positioning techniques used (e.g., TDoA, AoD, RTT) with the mobile access nodes for estimating WTRU position.

The one or more methods may include device attributes and/or parameters. For example, the WTRU may provide information on the number of antenna elements/panels, number of RF chains (e.g., for GNSS, non-GNSS), antenna configuration info, bandwidth supported (e.g., per RF chain), and processing capability for transmission/reception and fusing RF and timing measurements and/or GNSS-PRS measurements.

The one or more methods may include an accuracy achievable. For example, the WTRU may provide the one or more levels of positioning accuracy (e.g., per antenna element/panel, per-Rx/Tx RF chain), that may be achievable when using mobile access nodes. A WTRU may indicate information on the timing error group (TEG) including WTRU Tx TEG IDs, WTRU Rx TEG IDs, WTRU Rx-Tx TEG IDs, for example. WTRU may also send the association info between SRSp resources and WTRU Tx TEG IDs, for example. A WTRU may indicate whether it is possible for simultaneously perform measurements of GNSS and non-GNSS signals (e.g., PRS received from GEO, MEO, and/or LEO satellites). In examples, the WTRU may indicate the accuracy improvement when combining measurements of GNSS signals and non-GNSS signals (e.g., PRS). A WTRU may also indicate the priority value and/or preferred value when using GNSS and non-GNSS measurements.

The one or more methods may include one or more signal measurements and/or estimations. For example, the WTRU may provide information on the measurements made on GNSS and/or non-GNSS signals such as PRS (e.g., time of arrival (ToA), timestamp, RSRP, RSTD measurements).

In examples, the WTRU may provide information on the timing advance/alignment (TA) value measured/estimated by WTRU. Such estimation of the TA may be associated with a WTRU-specific TA value and/or may be performed by WTRU based on measurement of GNSS signals, estimation of WTRU location, and/or assistance data received from network (e.g., common or cell/beam specific TA), for example.

The positioning of a WTRU (e.g., target WTRU) using one or more mobile nodes may be initiated based on initial and/or reference locations, and/or trajectory. For example, the WTRU may provide information (e.g., identifiers) on availability/accessibility to one or more reference locations associated with positioning reference units (e.g., WTRUs, TRPs, gNBs, cells, NTN nodes, geostationary satellites), any detectable landmarks or reference points (e.g., associated with common/cell-specific TA value), possibly in proximity with the WTRU. The WTRU may also provide the distances/ranges to the identified reference locations, for example.

In examples, the WTRU may provide info on the GNSS nodes, NTN nodes or satellites (e.g., IDs) that may be detectable to the WTRU, possibly in one or more time windows. The WTRU may provide information on initial measurements made on the signals received from the reference satellites (e.g., ToA, and/or RSRP measurements with timestamps), for example. The WTRU may also provide the trajectory information of the detectable reference satellites (e.g., in terms of known trajectory IDs, or ToA/RSRP measurement and associated timestamp), for example.

For example, the WTRU may also indicate information (e.g., IDs) on one or more positioning areas and/or zones, possibly associated with the coverage area of one or more cells/beams/satellites/TRPs/gNBs, in which the WTRU was previously located, currently located and/or expected to be located at different time instances.

The positioning of a WTRU (e.g., target WTRU) using one or more mobile nodes may be initiated based on information on power saving modes. For example, the power saving modes supported by WTRU and/or configured by network may be provided, possibly including the timing info (e.g., timestamp) for when the WTRU has previously transitioned into or expected to transition into RRC CONNECTED, RRC INACTIVE, RRC IDLE or any other combination of power savings modes/states.

The information on power saving modes may include one or more preferred configurations or preferred parameters associated with CDRX/DRX (e.g., cycle time on-duration, inactivity timer duration), for example.

WTRU may also indicate the priority value and/or preferred value associated with power saving modes/states supported, possibly along with location/area info and/or timing info on where/when such priority/preferred values may apply, for example.

The triggering events/conditions monitored by a WTRU for sending the capability information and/or assistance information for using mobile access nodes may include reception of indication or LCS/LPP request from higher layers/application/network. For example, the WTRU may send the info/indication when triggered by the LCS client/application in the WTRU (e.g., MO-LR) or in network (e.g., MT-LR, deferred MT-LR, NI-LR). In this case, LCS client may provide reference time (e.g., scheduled location time, including one or more time instance at which the WTRU location is requested), and/or reference/initial locations (e.g., satellites, TRPs, PRUs) for example. The WTRU may receive the indication from LCS client in any of the following: LCS message, LPP message, AS layer signaling/channels (e.g., RRC, MAC CE, DCI, data).

In examples, the WTRU may send capability/assistance information upon receiving an LPP request message from network (e.g., request for capability info). The request message may include a request for information related to measurements (e.g., GNSS, non-GNSS), capability to support/perform positioning with mobile satellites/TRPs. WTRU power saving modes, trajectory, reference location/time, accuracy attributes, etc.

The triggering events/conditions monitored by a WTRU for sending the capability information and/or assistance information for using mobile access nodes may include detection reference locations and/or times. For example, the WTRU may send the info/indication when detecting one or more reference/initial locations (e.g., satellites, TRPs, PRUs, positioning areas) and/or at reference time instances (e.g., scheduled location time).

The triggering events/conditions monitored by a WTRU for sending the capability information and/or assistance information for using mobile access nodes may include event triggered and/or periodic. For example, the WTRU may send info/indication periodically, possibly based on one or more periodicity values configured by network. In examples, the WTRU may send updated/new capability/assistance info when detecting any change in capability/assistance info with respect to previous occasion when the info may be sent.

The triggering events/conditions monitored by a WTRU for sending the capability information and/or assistance information for using mobile access nodes may include change in radio conditions, positioning measurements, and/or positioning errors. For example, the WTRU may send the info/indication when triggered by a change in the radio conditions detectable at the WTRU. In examples, a WTRU configured to perform measurements on DL-PRS/CSI-RS/SSB/GNSS signals or estimation of TA values (e.g., WTRU specific TA), may send the info when the measurement values (e.g., RSRP, RSD, ToA, RSSI) increases/decreases by certain corresponding threshold values.

The WTRU may send any indication/information to network (e.g., gNB, LMF), possibly based on one or more of the triggering events and/or conditions described herein. The indication/information sent by WTRU may include capability information, a request for assistance data (e.g., trajectory/ephemeris data of mobile access node/satellite), a request for new/updated SRSp/PRS configuration, a request for activating/deactivating a preconfigured SRSp/PRS configuration, an indication for informing start of SRSp transmission or start of PRS measurement, and/or an indicating detection of triggering event (e.g., detection of a satellite, mobile TRP, identification of a matching trajectory for a satellite/mobile TRP, detection of errors during measurements).

In examples, the WTRU may receive assistance data and/or configuration information for supporting positioning procedures and/or approaches (e.g., DL-based, UL-based, DL+UL based, GNSS) when using one or more access nodes which may be mobile. The assistance data may be received in positioning SIB (e.g., broadcast with a configured periodicity in posSIB), LPP message(s), or AS layer signaling/channels (e.g., RRC, MAC CE, DCI, PDSCH). The assistance data and/or configuration info may be received by WTRU from the LMF (e.g., via LPP), gNB (e.g., RRC signaling/messages) and/or the access node/satellite (e.g., via AS layer signaling), for example.

The WTRU may receive the assistance data/configuration information associated with mobile access nodes due to one or more triggers. The one or more triggers may include sending a request. For example, the WTRU may send a request for assistance data to network (e.g., LPP message on-demand SI, AS layer signaling) indicating info/identifiers/configuration/parameters associated with one or more mobile access nodes. The WTRU may then receive the corresponding assistance data. In examples, the WTRU may receive the assistance data (e.g., in LPP message) after sending capability information and/or any other indications/messages (e.g., on-demand request, LCS messages, LPP messages, positioning info/report).

The WTRU may periodically receive the assistance data/configuration information associated with mobile access nodes. For example, the WTRU may be configured by network to receive assistance data periodically with a certain configured periodicity. The WTRU may request to change the periodicity for receiving assistance data based on detection of one or more events, such as change of satellite, detection of change of mobility state of mobile access node/satellite, detection of change in mobility state of the WTRU (e.g., change from stop state to mobile state), detection of change in trajectory of satellite, etc., for example.

The one or more triggers may comprise detection of one or more configured events and/or conditions. For example, the WTRU may receive one or more assistance data associated with mobile access nodes and/or positioning methods/schemes (e.g., PRS configurations). The WTRU may store the assistance data and retrieve for future positioning procedures/sessions (e.g., LPP sessions), for example. The WTRU may also receive validity conditions (e.g., positioning area, time and/or trajectory validity) and/or events associated with storing/using/releasing the assistance data. In this case, the WTRU may use the preconfigured assistance data so long as the validity conditions are valid and/or no events invalidating the preconfigured assistance data are detected by WTRU.

In examples, the WTRU may receive updated/new assistance data when the validity conditions expire and/or events invalidating the preconfigured assistance data are detected by WTRU, possibly based on an indication sent by WTRU to network reporting the expiry of validity conditions, detection of events and/or request for new/updated assistance data.

The assistance data and/or configurations received by a WTRU may include identifiers, indexes, and/or flags. For example, the WTRU may receive IDs/indexes of one or more access nodes along with an indication/flag indicating the mobility status of the access nodes. For example, fixed/stationary access node and mobile access nodes may be indicated with different flag values. In examples, where a mobile access node may be subject to different mobility states at different time instances/durations, including moving with a fixed speed, stopping, resuming movement, increasing/decreasing speed, etc., the WTRU may receive information on mobility state/status of the access node, possibly along with the time instance/duration when the mobility state changes or expected to change.

The assistance data and/or configurations received by a WTRU may include one or more measurement/transmission time instances and/or time windows. For example, the WTRU may receive info on one or more measurement/transmission time instances (e.g., t0, t1, t2, . . . , ti), indicating the time slots/occasions when the WTRU may perform PRS measurements and/or SRSp transmissions. Any of the time instances may be associated with a start offset time slot (e.g., ti−T1, corresponding to the earliest time slot for starting positioning measurements/transmissions), duration (e.g., number of time slots) and a stop offset time slot (e.g., ti+T2, corresponding to the latest time slot for stopping positioning measurements/transmissions), for example. The separation duration between different time instances may be configured to be fixed or variable. In the case when the duration between time instances is fixed, the WTRU may perform positioning measurements/transmissions periodically with a fixed periodicity, for example.

In examples, the time instances may correspond to the spatial/location separation from one instance to another by a mobile access node/satellite, which may travel over certain speed and/or over a trajectory/orbit.

For example, the WTRU may receive one or more time windows, indicating a positioning duration when the WTRU may perform PRS measurements and/or SRSp transmissions from/to a mobile access node/satellite. In examples, the duration of a time window may correspond to the maximum latency for determining the WTRU location based on PRS measurements and/or SRSp transmissions.

In examples, the WTRU may receive a combination of one or more trajectories of mobile access nodes, possibly associated with different measurement time windows and/or different expected start/end time of measurements for each trajectory. For example, the start/end time for measurements may be indicated as differential/offset values with respect to a reference start/end time. When using multiple mobile access nodes for positioning, the WTRU may use different associated time windows sequentially for measurements, for example.

The measurement time instances and/or time windows may be identified by IDs/indexes and/or may be associated with the one or more mobile access nodes used by the WTRU for positioning, for example.

In examples, where the WTRU may be configured for multi-round trip time (RTT) positioning with one or more mobile access nodes, the WTRU may receive the RTT configuration including a set of time instances for performing PRS measurements and a set of time instances for performing SRSp transmissions. The time instances corresponding to PRS measurements and SRSp transmissions may be separated by certain time duration, which may be aligned with the trajectory and/or mobility attributes (e.g., speed) of the access node/satellite, for example.

The assistance data and/or configurations received by a WTRU may include separation criteria. In examples, the WTRU may consider a mobile access node/satellite as a separate TRP/node at different measurement time instances, depending on a number of factors including the trajectory, speed (e.g., orbit speed) of the mobile node, direction/orientation of movement of the node/cell/beam with respect to direction/location of WTRU, etc.

For example, given a velocity value for a mobile node (e.g., satellite), the WTRU may consider the mobile node as separate node at different time instances when the time instances are separated by at least a certain time duration and/or may correspond to the spatial separation of the node by at least a certain distance. The distance may be associated with any of the following: horizontal distance, vertical distance (e.g., altitude when considering a satellite, or drone), orbital/angular distance/length over an arch or a segment of the orbit, etc.

The separation criteria may be associated with the separation based on time duration (e.g., between at least two measurements) and/or distances (e.g., movement of node/satellite from one location to another), for example. The WTRU may receive from network (e.g., LMF, gNB) the separation criteria for selecting a mobile access node/satellite for positioning and/or for determining when to perform measurements/transmissions from/to the selected mobile node/satellite. The one or more separation criteria received by WTRU may be associated with any of: an ID/index, a mobile access node/satellite, one or more gNBs/TRPs, PRS configurations and SRSp configurations.

In examples, any positioning measurement and/or transmissions performed by WTRU in the intermediary durations and/or distances within separation criteria may be considered as repetitions. For example, when configured with separation criteria indicating the WTRU to perform PRS measurements separated by at least a duration of T ms (e.g., first and second PRS measurements may be performed by WTRU T ms apart), any PRS measurements performed within T ms may be considered as repetitions. The WTRU and/or network may consider the PRS measurements and/or SRSp transmissions as repetitions when the measurements and/or transmissions are performed within the separation criteria. Such repetition for PRS measurements and/or SRSp transmissions may be performed periodically and/or when detecting a triggering event (e.g., ToA, and/or RSRP of PRS below/above threshold), possibly for improving positioning accuracy, for example.

In examples, the WTRU may be configured with measurement instances. The WTRU may receive periodicity of the measurement instance from the network. At each measurement instance, the WTRU may make measurements on PRSs transmitted by satellite (e.g., RSRP, RSTD, ToA, AoA). The WTRU may determine the measurement periodicity based on the configured separation criteria and/or number of repetitive measurements. The separation criteria may be indicated in terms of measurement instances by the network. For example, when the separation criteria is L measurement instances, it indicates that when the WTRU makes measurement at every L measurement instance, the measurement is considered unique (e.g., correlation between two consecutive measurements is sufficiently low). The number of repetitive measurements may be the number of measurements within a predefined interval. Repetitive measurements may be used to accumulate measurements such that averaging (e.g., average of RSRP) of measurements can be performed at the WTRU and/or network. The WTRU may be configured to make K repetitive measurements. In examples, the WTRU may be configured to make K repetitive measurements within a window of L measurement instances. In examples, the WTRU may be configured to aggregate K measurements which are collected at every L measurement instance. The WTRU may indicate to the network the aggregated measurements by associating a flag with the aggregated measurements. The WTRU may determine to make K measurements within the window of L measurement instances or aggregate measurements based on one or more of the following conditions.

Whether K is less or equal to L. If the condition is satisfied, the WTRU makes K measurements within a window of L measurement instances. If K is greater than L, the WTRU determines to aggregate K measurements which are measured at every L measurement instance.

Latency requirement for positioning: if the latency requirement for positioning is less than the threshold, WTRU makes K measurements within a window of L measurement instances. If the requirement is above or equal to the threshold, the WTRU makes the WTRU determines to aggregate K measurements which are measured at every L measurement instance

The assistance data and/or configurations received by a WTRU may include positioning configurations. For example, the WTRU may receive one or more PRS configurations/resources (e.g., IDs) and/or SRSp configurations/resources which may be associated with/intended for positioning using one or more mobile access nodes.

The PRS/SRSp configurations may include one or more frequency layers, resources, resource sets, beams and/or access nodes/TRPs/satellites associated with the indicated PRS/SRSp configurations. For example, the one or more PRS/SRSp configurations associated with satellites may include a combination of relatively low/high number of frequency layers, bandwidth (e.g., frequency resources), periodicity, density of resources, number of beams, etc.

The PRS/SRSp configurations received by WTRU may be associated with one or more trajectories applicable to the mobile access nodes used by WTRU for positioning. For example, the WTRU may use a first PRS configuration (e.g., for PRS measurements) when a selected mobile access node/satellite follows a first trajectory. The WTRU may switch to a second PRS configuration when the mobile access node/satellite follows a second trajectory, for example.

The types of PRS/SRSp configurations received by WTRU may include aperiodic, semi-persistent, periodic, along with timing info associated with the different types such as start time/slot, periodicity and stop time/slot, for example.

In examples, where the WTRU may be configured for multi-round trip time (RTT) positioning with one or more mobile access nodes, the WTRU may receive both the PRS configurations and SRSp configurations.

For example, the WTRU may also receive information on one or more measurement gap configurations (e.g., IDs), which may be associated with the PRS configurations to be used during measurements. Such measurement gap configurations may be aligned with the measurement time instances and/or activated during measurements, for example.

The assistance data and/or configurations received by a WTRU may include trajectory/ephemeris data of mobile access node/satellite. For example, the WTRU may receive the trajectory information associated with the one or more mobile access node/satellite which the WTRU may use for positioning.

In examples, the trajectory/ephemeris info may correspond to one or more points in space (e.g., location coordinates, absolute location, or relative location with respect to a reference location/point) associated with where a mobile access node/satellite may be located (e.g., time 1: location 1, time 2: location 2, time 3: location 1).

In examples, the location info and/or the trajectory info of the mobile access node/satellite may be associated with one or more accuracy/reliability values. Such accuracy/reliability may be indicated to the WTRU in the form of horizontal/vertical positioning accuracy values (e.g., <1 cm, <1 m), confidence interval, probability of the access node located within an area/zone, integrity (e.g., protection level/limit, alert limit), etc., for example. Such accuracy/reliability values corresponding to the location/trajectory info may indicated to WTRU to assist the WTRU for selecting a mobile access node for positioning and/or for calculating its location info, for example.

In examples, the WTRU may send a request message for an updated trajectory info of a mobile access node/satellite when determining the preconfigured trajectory info is invalid. When using one or more mobile access nodes for positioning, the WTRU may request and/or receive information on the correlation time or validity time indicating how long the trajectory/ephemeris data of the mobile access nodes may be valid. When using one or more geostationary satellites for positioning, the WTRU may also request and/or receive information on the validity time indicating how long the geostationary satellites may be valid.

In examples, a known trajectory may include different sub-trajectory types/components (e.g., straight path, orbital path, curve left, curve right), which may be associated with different measurement time instances. The trajectory/ephemeris info may be associated with one or more PRS/SRSp configurations which may be used by WTRU for performing measurements/transmissions when detecting the corresponding locations and/or time instances.

In examples, the WTRU may receive one or more trajectories (e.g., preconfigured), where each trajectory or subset of a trajectory may be associated with an ID, and/or information on which of the trajectories/subset of trajectories the mobile access node is expected to use/follow, possibly at different time instances/windows. When selecting a mobile access node/satellite for positioning and/or reporting the information on the actual/estimated trajectory followed by a selected mobile access node, the WTRU may send information on the trajectory/subset-of trajectory (e.g., IDs/indexes) to the network. For example, in the case when there may be uncertainty in the current or expected trajectories (trajectory/subset of trajectory) followed by a mobile access node, the WTRU may determine one or more trajectories that may best match with the preconfigured trajectories received from network (e.g., difference between preconfigured and actual/expected trajectory, possibly in terms of locations on a path, is less than a threshold). The WTRU may indicate to network the information (e.g., IDs/indexes) on the determined trajectories, possibly along with confidence/weight/probability values associated with the different determined trajectories, for example.

In examples, the WTRU may be configured with one or more trajectories associated with one or more satellites. In this case, the WTRU may determine to perform PRS measurements less frequently per-trajectory than in the case when the WTRU may be configured with one trajectory, for example.

The assistance data and/or configurations received by a WTRU may include priority values. For example, the WTRU may receive and/or configured with priority values associated with positioning with mobile access nodes or positioning with stationary access nodes (e.g., geostationary satellites, fixed TRPs). Such priority values may indicate the type of positioning approach the WTRU may use, for example.

For positioning with mobile access nodes, the WTRU may receive and/or configured with priority values associated with one or more mobile access nodes. Such priority values may indicate the preference for selecting/using a mobile access nodes/satellite for positioning, for example.

In examples, the WTRU may also receive priority values for the PRS/SRSp configurations, indicating the PRS/SRSp configurations to use when performing positioning with mobile access nodes. For example, the WTRU may select a satellite and/or an associated PRS/SRSp configuration based on the order of priority, where the satellite and/or PRS/SRSp configuration with the highest priority is used first for positioning measurements followed by the next highest priority when multiple satellites and/or configurations are available.

In examples, the WTRU may receive the priority values indicating satellites for the WTRU to search (e.g., prioritize GEO over LEO, prioritize quasi-geostationary over geostationary). Such priority values may indicate the network preferred satellites, possibly determined based on prior knowledge or system preference. Such priority values may be received by WTRU based on indication/information sent by WTRU to network, for example. For example, when the WTRU indicates preference for power savings (e.g., indication indicates battery life/capacity is low or below threshold), the WTRU may receive priority values for some satellites (e.g., satellites with low altitudes that may not require high RSRP at WTRU during measurements) that may allow the WTRU to conserve battery or improve power savings when searching/selecting the satellites for positioning, for example.

The assistance data and/or configurations received by a WTRU may include error thresholds. For example, the WTRU may receive one or more error thresholds associated with measurements (e.g., ToA threshold, RSRP threshold, RSTD threshold, RTOA threshold, number of multipaths) and/or positioning QoS (e.g., accuracy, integrity, latency).

In examples, the error threshold may be associated with the determination of dilution of precision (DOP). A DOP condition may be determined as follows: Given the location of WTRU, the difference/diversity in the location of one or more mobile satellites used for positioning at different measurement time instances is less than a threshold, for example. In this case, the WTRU may determine a positioning error when the calculated/detected DOP condition is above/below a DOP error threshold, for example.

The error threshold values may be used by WTRU for determining whether the positioning measurements are within the expected error bounds/thresholds and/or whether the positioning QoS requirements are met, for example, when performing measurements of DL signals (e.g., PRS, SSB) received from mobile access nodes at different time instances.

The assistance data and/or configurations received by a WTRU may include correction information and/or compensation information. For example, the WTRU may receive correction/compensation info/parameters to apply when performing measurements of DL signals (e.g., PRS) received from NTN nodes/satellites and/or mobile TRPs.

In examples, the correction info may include one or more TA values (e.g., common TA and/or WTRU-specific/differential TA values), for example. For example, the common-TA value may be associated with a reference point on the cell/beam transmitted by the access node/satellite. In examples, the reference point may correspond to a location at the center of the cell/beam transmitted by the access node/satellite. The WTRU may receive the location info (e.g., coordinates) of one or more reference points associated with the cell/beam transmitted by access node/satellite, for example. Such common TA and/or location info of the reference points may be used for determining the differential TA and/or the relative WTRU location, for example.

In examples, the WTRU may receive a set of common TA values associated with different reference points on a cell/beam and/or different transmission time instances (e.g., associated with the trajectory of a mobile access node/satellite), for example. Such set of common TA values may be associated with positioning configurations (e.g., SRSp configurations). For determining the TA value to use (e.g., differential TA and/or common TA) when performing SRSp transmission at a transmission time instance, WTRU may select a suitable common TA value based on the info received from the network (e.g., trajectory info, association info between transmission time instances and common TA values), for example.

The WTRU may also receive correction/compensation info/parameters to apply when performing transmissions of UL signal (e.g., SRSp) to NTN nodes/satellites and/or mobile TRPs.

The correction/compensation info/parameters may be used by WTRU for recovering from error conditions when the measurements/estimation are invalid, for example.

In examples, the correction info may be related to timing/phase errors (e.g., associated with satellite, and/or PRS config/resources), indicating the difference between the time instance/phase when the PRS is generated and transmitted by the gNB and/or satellite. The correction info may be related to timing/phase errors (e.g., associated with WTRU, and/or SRSp config/resources), indicating the difference between the time instance/phase when the SRSp is generated and transmitted by WTRU, for example.

In examples, the correction info received by WTRU may be related to timing/phase errors expected at different positioning/coverage/reference areas and/or time instances. The WTRU may use the corresponding correction info based on the PRS/SRSp resources, satellites/TRPs/gNBs, areas, time instances when performing measurements of PRS, and/or transmission of SRSp.

In examples, the WTRU may receive correction info/thresholds associated with error sources at the gNB/TRPs, mobile access nodes and/or channels/links (e.g., Uu link, feeder/backhaul link between gNB and satellite, relay link between WTRU and satellite), including synchronization errors, timing errors (e.g., gNB/access node/satellite Tx TEG IDs, Tx-Rx TEG IDs, Rx TEG IDs), multipath, LOS/NLOS, and errors in satellite trajectory/ephemeris data. Such correction info may be used by WTRU when operating in WTRU-based mode and/or when the WTRU estimates the trajectory of a mobile access node based on measurements at different time instances), for example.

The assistance data and/or configurations received by a WTRU may include reporting configuration. For example, the WTRU may receive reporting configuration to apply when sending the information on positioning measurements associated with mobile access nodes. For example, the reporting configuration may include the IDs/indexes to be used (e.g., LPP ID, satellite/NTN node ID, WTRU ID, positioning method ID). In examples, the reporting configuration may include on whether to report absolute/averaged/min/max values related to measurements made on the PRS (e.g., ToA, RSRP, RSTD measurements made on resources/beams/cells associated with PRS).

In examples, the reporting configuration may include the reporting periodicities (e.g., whether reporting is to be aligned with measurements/transmissions), offsets with respect to start/end of measurements, and events that the WTRU can monitor/detect for sending reports to network. For example, the WTRU may send a report on positioning measurements/estimation/uncertainty when detecting a change in radio conditions is detected (e.g., ToA and/or RSRP above/below a threshold), detecting change in mobility state of access node/satellite, and/or detection of change in mobile access node trajectory (e.g., access node deviates from a straight path).

The WTRU may include timing information (e.g., timestamps) in the reports, for indicating when the measurements are started/stopped at different time instances, for example. When configured with a set of measurement time instances, and/or when using the configured time instances for performing measurements of PRS received from mobile access node, the WTRU may send the set ID in the report, for example.

In examples, when WTRU performs prediction, extrapolation, and/or interpolation during time instances when PRS measurements (e.g., ToA) from mobile access nodes are not made, the WTRU may send the timing information (e.g., timestamps) related to start time, duration and/or stop time associated with prediction. When performing extrapolation/interpolation of measurements, the WTRU may send information on the uncertainty of the prediction, confidence value and/or weight values associated with different instances of the extrapolated/interpolated measurement values.

The assistance data received by WTRU may be common across different positioning areas (e.g., including multiple cells/TRP/gNB/access nodes) or specific to one or more cells/TRPs/gNBs/satellites. When the WTRU receives TRP/satellite-specific assistance data (e.g., associated with ID of TRP/satellite), the WTRU may use the associated assistance data when under the coverage of the TRP/satellite, for example.

A WTRU may perform one or more measurements (e.g., such as an RSRP and/or a ToA) of PRS received from a mobile satellite based on a time difference (e.g., RSTD) calculation made with respect to a reference point on the cell/beam associated with the satellite. The WTRU may be configured to receive configuration information from the network. The WTRU may perform a first RSRP and/or a first TOA measurement(s) of a PRS received from a satellite at a first measurement time instance. If the measured RSRP is greater than or equal to an RSRP threshold and the measured TOA minus the expected TOA at a reference point is less than a RSTD threshold, the WTRU may perform second RSRP and/or TOA measurement of the PRS at a second measurement time instance and perform a third RSRP and/or TOA measurement of the PRS at the second measurement time instance using an alternate PRS configuration. If the measured RSRP is less than the RSRP threshold, the WTRU may select an alternative satellite and/or perform a second RSRP and/or TOA measurements of the PRS at the second measurement time instance using the alternat PRS configuration. The WTRU may report to LMF the first, second, and/or third RSRP and/or TOA measurement to the LMF.

In examples, the location information of a WTRU may be determined in scenarios where one or more of the access nodes are mobile when using any of DL-based positioning approaches (e.g., DL-TDoA, DL-AoD). The location of the WTRU may be determined based on the signals (e.g., DL-PRS) transmitted by the mobile access nodes and/or measurements made by the WTRU.

In timing-based approaches (e.g., DL-TDoA, OTDOA), the distances between the WTRU and one or more mobile access nodes may be estimated at different time instances for determining the location of WTRU. The distance between the WTRU and the one or more mobile access nodes may be estimated based on a time of arrival (ToA). For example, ToA may refer to any measurement or estimation performed by WTRU for determining the time of reception or arrival of a DL signal (e.g., PRS, SSB, PSS/SSS signals, initial access messages such as Msg B, Msg 2, Msg 4). Such ToA measurement may include determination of SFN offsets, reception time slots, TA indication/command, timestamp, doppler shift/dilation, etc.

For example, when timestamps are used in the DL signal for indicating the ToA, the format (e.g., UTC time) and/or granularity (e.g., milliseconds) applied when indicating the time may allow for determining the distance travelled by the DL signal (e.g., from access node to WTRU) prior to reception at WTRU.

In examples, the ToA may be determined as a relative ToA (RTOA) measurement with respect to a reference ToA measurement. In this case, the reference ToA may be measured on PRS received from a reference node (e.g., geostationary satellite) or gNB/ground station, for example.

In examples associated with NTN, the WTRU may measure the ToA of PRS transmitted by a gNB/ground station and/or relayed by an NTN node/satellite. In this case, the ToA may be determined by WTRU based on the knowledge of time of transmission (e.g., via SFN/NR slot) or based on timestamp info carried explicitly or implicitly in DL signals (e.g., PRS). Such approaches for determining the ToA may be applicable when the WTRU and gNB are time synchronized (e.g., synchronized with respect to a common clock). The difference between time of reception and time of transmission may indicate the UL and/or DL distance travelled by the DL signal, for example.

The distance between the WTRU and the one or more mobile access nodes may be estimated based on an RSTD. For example, the RSTD may refer to the difference between the ToA of any DL signal (e.g., PRS, SSB) transmitted by an access node (e.g., satellite, NTN node, mobile TRP) and the ToA of a DL signal transmitted by a reference node (e.g., gNB, PRU, geostationary satellite).

The distance between the WTRU and the one or more mobile access nodes may be estimated based on an RSRP. For example, RSRP may refer to the received power measurements made on any DL signals (e.g., PRS, SSB, PSS/SSS signals, initial access messages).

The WTRU may perform any of the above measurements of the PRS received from mobile access node/satellite at one or more measurement time instances (e.g., configured via assistance data), periodically (e.g., using a configured periodicity value) and/or when triggered by events (e.g., measurement/estimation error above threshold), for example.

In angle-based approaches (e.g., DL-AoD), the distances and/or directions between the WTRU and one or more mobile access nodes may be estimated at different time instances based on measurements of RSRP, AoD, and/or AoA of the one or more PRS beams transmitted by access node/satellite. When using a mobile access node/satellite for positioning, the WTRU may use the same or different TX beams associated with PRS transmitted by the access node/satellite at different measurement time instances. Such information on the PRS TX beams used by the mobile access node/satellite may be received by WTRU as assistance data from the network, for example. The WTRU may use a corresponding RX beam, based on the assistance data, for performing measurements of the PRS TX beam, for example. Alternatively, when assistance data is not available or partially available, the WTRU may perform a beam selection procedure (e.g., by performing WTRU-based beam sweeping) to identify the TX beams used by the mobile access node/satellite at different measurement time instances, for example. In examples, the WTRU may determine/select the TX beam based on knowledge of the trajectory/ephemeris info associated with the mobile access node/satellite (e.g., configured in WTRU via assistance data).

In one solution, the WTRU may be configured for DL-based positioning with one or more access nodes which may be mobile, when using a WTRU-based positioning mode and/or a WTRU-assisted (e.g., network-based) positioning mode.

In a WTRU-based positioning mode, a WTRU may perform measurements of PRS received from the mobile access nodes and/or may calculates its location based on the measurements and the location info of mobile access node at different time instances when the measurements are made. The location info of mobile access nodes may be configured/received by WTRU as assistance data, for example. When calculating the WTRU location, corrections may be applied by the WTRU by accounting for any errors due to the location and/or relative movement of the WTRU with respect to the mobile access nodes, for example.

In a WTRU-assisted (network-based) positioning mode, a WTRU may perform measurements of PRS received from the mobile access nodes and send the measurement report to network (e.g., LMF, gNB) for calculating the WTRU location. The measurement report may include info of the mobile access node/satellite (e.g., satellite ID, trajectory ID) used for positioning and/or timestamps for indicating the time instances when the PRS measurements are made by the WTRU. The timestamps included by WTRU in the measurement report may be indicated as a relative time with respect to a starting/reference time. The measurements of PRS (e.g., ToA, RSRP) and the timestamps may indicate where the WTRU may be performing the measurements from with respect to the trajectory of the mobile access node/satellite transmitting the PRS, for example.

In examples, the WTRU may be configured to use one or more PRS configurations and/or PRS parameters (e.g., periodicity, bandwidth) based on the mobility attributes of the access nodes and/or WTRU. Such PRS configurations/parameters may be applicable for both WTRU-based and WTRU-assisted approaches, and may be intended to be used for ensuring high quality PRS measurements and positioning accuracy when using mobile access nodes. The mobility attributes associated with the mobile access nodes may include any of altitude, distance of the access node from WTRU, speed of access node, and direction of movement of access node with respect to WTRU, for example.

For example, the WTRU may select/determine to use a first PRS configuration (e.g., first set of PRS resources) with high resource density, high periodicity, high repetitions and/or high bandwidth when the speed of the access node is high (e.g., above a speed threshold above). Similarly, the WTRU may select/determine to use a second PRS configuration (e.g., second set of PRS resources) with relatively low density, low periodicity, and/or low bandwidth when speed of the access node is low (e.g., below a speed threshold value), for example.

In examples, for enabling the WTRU to select/determine a suitable PRS configuration/parameters, the WTRU may be preconfigured with one or more PRS configuration/parameters, one or more thresholds associated with the mobility attributes (e.g., speed, direction) and association information indicating the association between the mobility attributes and the PRS configurations/parameters. Such configuration information may be received by WTRU from network (e.g., LMF, gNB) as assistance data, for example.

In this case, when the WTRU is configured to use one or more mobile access nodes WTRU-based or WTRU-assisted DL positioning, the WTRU may determine the mobility attributes of the access nodes and select a suitable PRS configuration based on the determined mobility attributes. For example, the mobility attributes of the access nodes may be determined by WTRU based on indications/information received from network (e.g., via assistance data including the trajectory/ephemeris data) and/or directly from the mobile access node (e.g., via direct indications over Uu link or SL, indicating the trajectory, current/expected speed, current/expected direction, etc. corresponding to the access node). In examples, the WTRU may determine the mobility attributes based on measurements of signals (e.g., initial/default PRS or SL-PRS) received from the mobile access nodes, possibly over one or more time instances/durations. The WTRU may also estimate the trajectory of the mobile access node (e.g., association between location and time instances) based on the measurements of the received signals, for example.

Upon determining the mobility attributes, the WTRU may select one or more PRS configurations and/or PRS parameters to use for performing measurements of PRS received from the mobile access node based on the preconfigured assistance data, for example. The WTRU may send an indication (e.g., on-demand indication) to the mobile access node and/or to network (e.g., LMG, gNB) request configuring/activating the selected PRS configuration/parameter, for example. Alternatively, the WTRU may send to the access node and/or network the measurements (e.g., RSRP, doppler, or ToA measurements of the signals received from the access node), and/or indications on the mobility attributes (e.g., estimated speed, trajectory). The WTRU may receive from network or access node the PRS configurations/parameters and/or activation/deactivation indication triggering the use of the PRS configurations/parameters. The WTRU may perform measurements of PRS received from the mobile access nodes using the associated PRS configurations/parameters, for example.

In WTRU-based case, the WTRU may determine its location based on the PRS measurements performed using the one or more PRS configurations/parameters and other assistance data or estimations (e.g., trajectory info of the mobile access node). In WTRU-assisted case, the WTRU may send measurement reports to network, possibly including the info on the mobile access nodes used for positioning (e.g., IDs), timing info of the measurements (e.g., timestamps), estimated trajectory info of the mobile access nodes, and any relative movement/mobility attributes of the WTRU, for example.

In examples, the WTRU may select one or more mobile access nodes (e.g., satellites, TRPs) for positioning based on a configured selection criteria. The selection criteria may be received by WTRU from the network (e.g., as assistance data) and/or from any of the access nodes, mobile and/or stationary, for example.

In examples, corresponding to a transparent mode, the WTRU may not be directly aware that the one or more access nodes/TRPs indicated by the network for positioning are mobile. The WTRU may receive indications/assistance data (e.g., access node/satellite/TRP IDs) from the network, possibly along with PRS configurations and other assistance data such as measurement time instances. The WTRU may perform measurements of the PRS received from the mobile access nodes upon detecting a trigger associated with the mobile access node (e.g., detection of a configured ID in SSB associated with the mobile access node). The WTRU may perform measurements of the PRS received from the mobile access nodes upon measurement of DL signal received from the mobile access node (e.g., RSRP of initial PRS or SSB above a threshold). The WTRU may perform measurements of the PRS received from the mobile access nodes upon receiving an indication from network (e.g., LPP request for location info, indication configuring/activating measurement gap).

When reporting the measurements to the network, the WTRU may report according to the reporting configuration provided in assistance data or the WTRU may include some indications (e.g., timing info/timestamps indicating when the measurements are made) indicating the possible detection by WTRU that one or more of the access nodes may be mobile during measurements, for example.

In examples, the WTRU may be configured with selection criteria for selecting one or more mobile access nodes for positioning. The selection criteria may include one or more of the following.

The selection criteria may include trajectory and/or ephemeris data. For example, the WTRU may select a mobile access node/satellite when the mobile access node is observable/detectable by WTRU and/or the trajectory data of the mobile access node is aligned with a time window used by WTRU for positioning.

The selection criteria may include accuracy and/or reliability of location and/or trajectory info of a mobile access node. For example, the WTRU may select a mobile access node when the accuracy of its location info and/or trajectory info is above/below one or more configured threshold values. WTRU may not select an access node for positioning when the accuracy of mobile access node's location info is less than the threshold value, for example.

The selection criteria may include speed and/or direction of mobile access node/satellite. For example, the WTRU may select a mobile access node when its speed is above/below one or more configured speed threshold values. WTRU may not select an access node which may be fast moving, for example. The WTRU may select a mobile access node whose mobility direction is above/below one or more configured angle/direction threshold values, possibly relative to the direction of the WTRU, for example.

The selection criteria may include quality of measurements. For example, the WTRU may select a mobile access node when the measurement of a signal (e.g., initial/default PRS, SSB, PSS, SSS) received from the access node is above/below one or more configured threshold values. The measurements performed by WTRU may include any of ToA, AoA, RSTD, RSRP, etc., for example. Other measurements that the WTRU may perform for deciding whether to select a mobile access node include path loss, number of multipaths, LOS/NLOS identification, etc., for example. WTRU may not select an access node when the measurements of the signal indicate poor quality, for example.

The selection criteria may include a selection priority and/or preference. For example, the WTRU may select an access node/satellite for positioning based on the order of priority indicated by the network. The WTRU may select a mobile access node detectable by the WTRU with the highest priority followed by the next highest priority, for example. In examples, a stationary access node (e.g., fixed TRP, geostationary satellite) may be indicated/assigned with higher priority than a mobile access node. In this case, the WTRU may select a mobile access node for positioning when (e.g., only when) any stationary access nodes are not detectable/available (e.g., WTRU is unable to detect an ID of a stationary TRP in SSB or unable to measure PRS from a stationary TRP with RSRP above a threshold), for example.

The selection criteria may include availability of assistance data associated with an access node. For example, the WTRU may select an access node/satellite when the assistance data including one or more PRS configurations, measurement time instances, separation criteria, etc., associated with the access node/satellite is available, preconfigured in WTRU, and/or valid for usage.

The selection criteria may include a time window and/or a latency for positioning. For example, the WTRU may select one or more mobile access nodes whose trajectories may overlap with the time window used by WTRU for positioning. The time window for positioning may include a start time instance/slot, end time instance/slot, and/or a maximum time duration/latency, for example, during which the WTRU may perform measurements of PRS received from one or more mobile access nodes.

In examples, the WTRU may be configured to use a set of access nodes/TRPs for positioning, where the set may include a combination of different mobile access nodes/TRPs or a combination of mobile and stationary access nodes/TRPs. The use and/or selection of such a set may allow the WTRU to simultaneously use different types of access nodes/TRPs or to switch between different mobile access TRPs or between stationary TRPs and mobile TRPs. The WTRU may switch between using different access node/TRP types based on detection of one or more events including temporary blockage of the link between the WTRU and a TRP, poor coverage conditions at WTRU (e.g., RSRP of PRS received by WTRU from any of the TRPs is below threshold), detection of DOP conditions, increase/decrease in access node speed, change in trajectory, etc., for example.

When some of the assistance data (e.g., latest location, trajectory info) or indications are received from the mobile TRP, the WTRU may combine the assistance data from different sources (e.g., LMF in existing LPP session, preconfigured in WTRU in previous LPP sessions, directly from mobile TRPs) for determining the suitable PRS configurations to use when performing measurements of PRS received from a combination different types of TRPs, for example.

In examples, when the WTRU is configured (e.g., via assistance data) with options to select between a stationary and mobile access nodes/TRP, the WTRU may initially select one or more fixed/stationary TRPs for performing DL-PRS measurements based on the selection criteria (e.g., stationary TRP may have higher priority than mobile TRP). The WTRU may then switch to selecting and/or using a mobile TRP when triggered by an event (e.g., link blockage) based on the configured assistance data associated with the mobile TRP, for example. The assistance data and/or PRS configurations/parameters associated with the mobile TRP may be different than that associated with a stationary TRP. The WTRU may be indicated by network (e.g., via LPP or AS-later signaling) and/or select a suitable assistance data and PRS configurations when switching between stationary and mobile TRPs, for example. In WTRU-assisted mode, the WTRU may report to the network the timing info/timestamps indicating the time instances when switching between stationary and mobile TRPs, along with the TRP IDs and PRS measurements, for example.

In examples, a WTRU may send positioning information, indications, and/or reports (e.g., location measurements/estimations) to the network, for example, based on the measurements performed on the PRS received from one or more mobile access nodes. In examples the WTRU may send the positioning information based on reporting configuration received in assistance data. The WTRU may send the positioning information/reports after completion of the measurements and/or upon detecting triggering events/conditions as described above (e.g., reception of request from network, periodic reporting, switching between different types of mobile access nodes or different configurations, detection of errors, etc.), for example. In examples, related to UL-based positioning, the WTRU may send indications to network due to any of the following: when requesting for SRSp configurations and/or activation/deactivation of preconfigured SRSp configurations, and switching between different SRSp configurations, for example.

The positioning information/reports may be sent by the WTRU, periodically or based on event triggers, in any of the following: LPP messages (e.g., LPP provide location information message, AS layer messages (e.g., RRC signaling, MAC CE, UCI, PUSCH data). The positioning information sent by the WTRU, possibly when using mobile access nodes for positioning, may include one or more of the following.

The positioning information sent by the WTRU may include location information and/or measurements. For example, the WTRU may send the determined/estimated WTRU location (e.g., coordinates, relative location with respect to a reference point/location) and/or measurements used for determining/estimating WTRU location. The WTRU may send the location information using absolute values (e.g., normal coordinates) or truncated values (e.g., abbreviated coordinates), for example. Such information may be sent along with the timing information (e.g., timestamps indicating when the measurements/estimations are performed) and/or the IDs/indexes of configurations applied during measurements including PRS configurations, measurement time instances/windows and separation criteria, for example. The WTRU may transmit an indication of at least one of a mobile network node identification or WTRU location information to a network or a satellite.

When sending timing info (e.g., timestamps) the WTRU may report absolute time (e.g., UTC) or differential time (e.g., difference in the time with respect to previous/reference time instance/occasion), for example.

In examples, the WTRU may send information on any other measurements and estimations, including measurements of GNSS signals (e.g., for estimating initial WTRU location), measurements made on RRM signals (e.g., CSI-RS, SSB) and estimation of TA (e.g., WTRU or cell specific TA), possibly in addition to the PRS measurements. Such information may be used for improving the accuracy of the WTRU location, for example.

The positioning information sent by the WTRU may include access node information. For example, the WTRU may send info on the access nodes/TRPs/satellites (e.g., IDs/indexes) used during positioning. The WTRU may also send the timing info (e.g., timestamps) indicating the start/end time when using or switching to a mobile access node, for example. In examples, the WTRU may send info on the one or more PRS configurations/parameters (e.g., IDs/indexes) used in association with the selection a mobile access node. In examples, the WTRU may send info (e.g., IDs, timing info/timestamps) on any reference units such as PRUs, reference points, reference access nodes/TRPs, and/or reference satellites (geostationary satellite), when using the reference units for differential measurements (e.g., RSTD, differential timing/phase).

The positioning information sent by the WTRU may include satellite related information. For example, when the WTRU is configured with DL-TDoA or DL-AoD positioning approaches using one or more mobile satellites, the WTRU may report one or more of the following. The WTRU may report a satellite ID and/or trajectory/ephemeris data ID. The WTRU may report a reference time used (e.g., absolute time or relative time, where the time may be based on GNSS synchronization time or SFN provided by network), based on which RSTD measurements/calculations are made, for example. The WTRU may report a reference point used (e.g., location on the cell/beam transmitted by the satellite and/or used by WTRU), based on which location/TA estimates are made, for example. The WTRU may report a PRS/SRSp configurations (e.g., IDs) used, including one or more cells/beams (e.g., cell/beam IDs), which may be associated with the satellites and/or trajectory of the satellites. The WTRU may report a ToA, RSRP, and/or RSTD measurements made on the PRS and/or timing info (e.g., timestamps) indicating when the measurements are made.

The positioning information sent by the WTRU may include error information. For example, the WTRU may also indicate any errors due to time/phase/power measurements (e.g., timing/phase error group IDs), and errors related to trajectory of mobile access node (e.g., difference between the expected and estimated trajectory/location). In examples, the WTRU may report detection and/or measurements of error sources (e.g., multipath, NLOS, ionospheric errors, tropospheric errors).

The positioning information sent by the WTRU may include an achievable positioning QoS. For example, the WTRU may send information on the positioning QoS achievable (e.g., accuracy, integrity, latency, power savings), possibly with respect to the requirements/KPIs received from the network (e.g., LMF, gNB). The WTRU may report the QoS info (e.g., accuracy, latency, integrity) on a per mobile access node/satellite basis, for example.

The positioning information sent by the WTRU may include WTRU mobility and/or movement information. For example, the WTRU may send information on mobility states (e.g., stationary, mobile with low/high speed), mobility/movement attributes (e.g., speed, direction, distance travelled in direct/straight path) and/or trajectory info (e.g., list of locations and/or list of cell/TRP IDs detected by WTRU over a time duration).

The positioning information sent by the WTRU may include trajectory info of mobile access nodes/TRPs. For example, when estimating the trajectory of the mobile access node/TRP (e.g., based on PRS or SL-PRS measurements over a time duration), the WTRU may send the trajectory info (e.g., trajectory IDs, absolute location or relative location of access node with respect to WTRU at different time instances/timestamps), range info (e.g., distance/direction of access node/TRP relative to WTRU) and mobility attributes (e.g., speed, and/or direction of movement access node).

The positioning information sent by the WTRU may include prediction and/or interpolation information. For example, the WTRU may send the predicted/extrapolated location information/measurements (e.g., for time instances where measurements are not made or missed) and/or the interpolated location information/measurements (e.g., estimations between two or more time instances). The WTRU may send the timing info (e.g., timestamps) associated with prediction/interpolation, indicating the time instances/windows when the predictions/interpolations are applied by the WTRU, for example. In examples, the WTRU may also indicate the confidence level and/or uncertainty associated with the predicted/interpolated location information/measurements.

The WTRU may send the positioning information (measurement reports/location estimates) to network (e.g., LMF, gNB) and/or access node/satellite in one or more of an LPP Message, AS-layer signaling (e.g., RRC signaling/messages, UL MAC CE or UCI), and/or initial access messages (e.g., RACH preamble, Msg A, Msg 1, Msg 3). For example, the WTRU with an LPP session may send the positioning information to network in NAS/LPP message(s) using SRBs (e.g., SRB1, SRB2, SRB3) or DRBs.

When operating in INACTIVE/IDLE mode, the WTRU may use small data transmission (SDT) or early data transmission (EDT) configurations for sending the positioning information/reports. The SDT/EDT configurations received by WTRU from network (e.g., serving gNB) may include information on the validity conditions for maintaining SDT/EDT (e.g., TA timer), maximum data volume threshold for the payload of messages, periodicities, resource grants (e.g., configured grants for SDT), etc.

For minimizing the amount of reporting and/or transmission of positioning information, the WTRU may send differential positioning information (e.g., delta) with respect to the information sent in the previous reporting instances, for example. In examples, the different types of positioning information (e.g., location info determined via measurements/estimation, error info) may be associated with different priority values, where the priority values may possibly be received by WTRU as assistance data from network. In this case, the WTRU may apply different reporting periodicities or urgency levels for sending the positioning information based on the priority associated with the information type to be reported. For example, the positioning information which may include a change value greater than a threshold with respect to previously reported information may be sent with higher periodicity or triggered with higher urgency level (e.g., use SR/BSR configuration associated with high priority traffic). Likewise, the WTRU may send information related to errors and/or change with respect to expected trajectory of the mobile access nodes with higher periodicities and/or higher urgency level, for example.

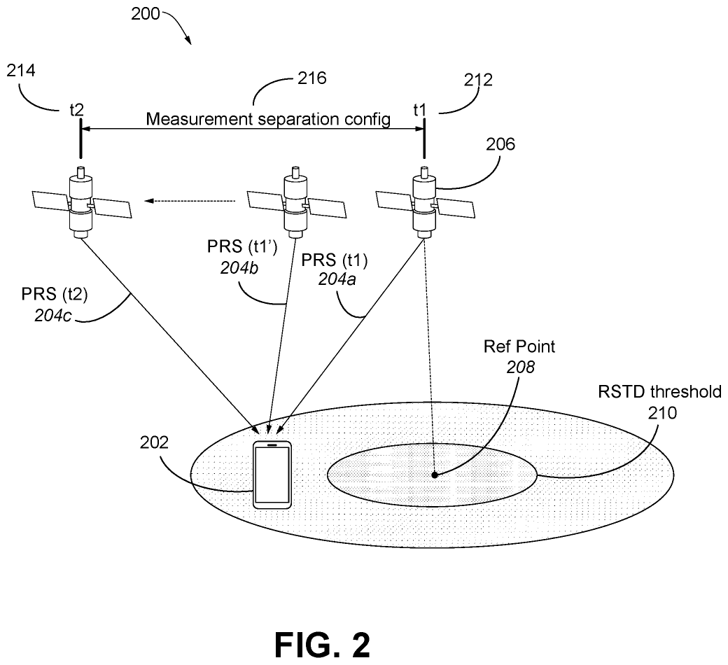

FIG. 2 depicts an example scenario 200 where a WTRU 202 may perform one or more measurements (e.g., RSRP, ToA) of one or more PRSs 204a, 204b, 204c received from a mobile satellite 206. The WTRU 202 may perform one or more measurements (e.g., RSRP, ToA) of the one or more PRSs 204a, 204b, 204c received from the mobile satellite 206 based a time difference (e.g., RSTD) calculation made with respect to a reference point 208 on the cell/beam associated with the mobile satellite 206. An example procedure applied by the WTRU 202 for performing DL-based positioning with the mobile satellite 206 may include one or more of the following. The WTRU 202 may receive configuration info from the network. The configuration information may include one or more PRS configuration, including at least a default/first PRS configuration and a second/alternative PRS configuration. The second PRS configuration may include PRS resources with high repetition factor, for example.

The configuration information may include a set of measurement time instances (e.g., 1st time instance 212 and 2nd time instance 214), indicating when to measure PRS received from the mobile satellite 206. The configuration information may include one or more reference points (e.g., such as reference point 208) associated with each measurement time instances and expected ToA values (e.g., timestamps) of PRS at the one or more reference points. The configuration information may include an RSRP threshold (e.g., used for determining the channel/link quality between WTRU and satellite). The configuration information may include an RSTD threshold 210. The RSTD threshold 210 may be used for determining the relative location of the WTRU 202 with respect to the reference point 208 on the cell associated with the mobile satellite 206.

The WTRU 202 may perform a first set of RSRP and/or ToA measurements of a first PRS 204a received from the mobile satellite 206 at the first measurement time instance 212. The WTRU 202 may perform the first set of RSRP and/or ToA measurements using the first/default PRS configuration.

If the measured RSRP is greater than or equal to an RSRP threshold, and if the measured ToA-expected ToA at the reference point 208 is less than the RSTD threshold 210, the WTRU 202 may perform a second set of RSRP and/or ToA measurements of a second PRS 204c at a second measurement time instance 214 using the first/default PRS configuration. The WTRU 202 may send a measurement report to the network (e.g., LMF), including the first and second set of PRS measurements (e.g., RSRP and ToA measurements along with timestamps indicating when the measurements are made)

If the measured RSRP is greater than or equal to an RSRP threshold and if the measured ToA-expected ToA at the reference point 208 is greater than or equal to the RSTD threshold 210, the WTRU 202 may perform a third set of RSRP and/or ToA measurements of a third PRS 204b using the second PRS configuration before the 2nd measurement time instance 214. The WTRU 202 may perform the second set of RSRP and/or ToA measurements of the second PRS 204c at the second measurement time instance 214 using the second PRS configuration. The WTRU 202 may send a measurement report to network, including the first, second and third set of PRS measurements (e.g., RSRP and ToA measurements, along with timestamps indicating when the measurements are made).

If the measured RSRP is less than an RSRP threshold, the WTRU 202 may perform a set of second RSRP and/or ToA measurements of the second PRS 204c at the second measurement time instance 214 using the second PRS configuration. Additionally or alternatively, the WTRU 202 may select an alternative satellite for PRS measurements, for example, based on the measured RSRP and/or the measured ToA. The WTRU 202 may report to LMF the first and second set of PRS measurements (e.g., RSRP and ToA, possibly along with timestamps indicating when the measurements are made).

FIG. 2 depicts an example scenario 200 where a WTRU 202 may perform one or more measurements (e.g., RSRP, ToA) of one or more PRSs 204a, 204b, 204c received from a mobile satellite 206 at t1 212, t1′, and/or t2 214 (e.g., indicated by the measurement configuration, also known as measurement separation configuration 216) based on a time difference (e.g., RSTD) calculation made with respect to a reference point 208 on the cell/beam associated with the mobile satellite 206. The WTRU 202 may compare the time difference calculation with a configured RSTD threshold value 210 for determining whether the WTRU 202 performs additional measurements of PRS(s) received from the mobile satellite 206. The RSTD threshold 210 may be centered around the reference point 208. When the WTRU 202 has exceeded the RSTD threshold 210, the WTRU 202 may perform additional measurements of PRS(s) 204a, 204b, 204c. For example, the WTRU 202 may perform one or more measurements (e.g., RSRP, ToA) of PRS 204a,b received from a mobile satellite 206 at t1 212 and t1′ (e.g., indicated by the measurement configuration) based on a time difference (e.g., RSTD) calculation made with respect to the reference point 208 on the cell/beam associated with the mobile satellite 206.

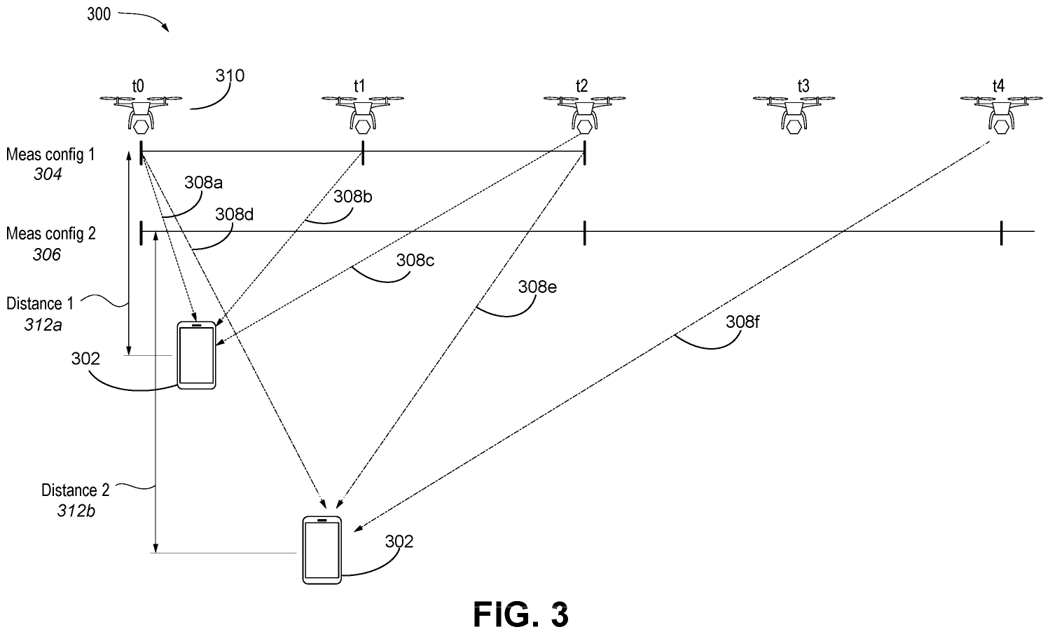

FIG. 3 depicts an example scenario 300 for determining which measurement configuration to use for measuring a PRS received from a mobile access node. A WTRU 302 may determine a measurement configuration 304, 306. The measurement configuration 304, 306 may include a set of time instances t0, t1, t2, t3, and/or t4 with different parameters (e.g., periodicity, duration), to use for measuring PRSs 308a, 308b, 308c, 308d, 308e, 308f received from a mobile access node 310 (e.g., drone) based on the relative distance 312a, 312b of the WTRU 302 with respect to the mobile access node 310. An example procedure applied by WTRU 302 for determining the measurement configuration 304, 306 to use during DL-based positioning with the mobile access node 310 may include one or more of the following.

The WTRU 302 may receive configuration information from the network. The configuration information may include a first measurement configuration 304, a second measurement configuration 306 (e.g., IDs), a first distance threshold, and a second distance threshold. The first measurement configuration 304 may include a set of time instances t0, t1, and/or t2 with high periodicity and short measurement time duration/window, for example. The first measurement configuration 304 may be used when the relative distance of the WTRU 302 with respect to the access node 310 is low (e.g., WTRU 302 is in close proximity/near to the access node 310). The second measurement configuration 306 may include a set of time instances t0, t2, and/or t4 with low periodicity and long measurement time duration/window, for example. The second measurement configuration 306 may be used when the relative distance of the WTRU 302 with respect to the access node 310 is high (e.g., WTRU 302 is far from the access node 310). The first distance threshold and the second distance threshold may be used for comparing the distance between the WTRU 302 and the mobile access node 310.

The WTRU 310 may perform a first set of measurements (e.g., RSRP, RSTD) of a first PRS 308a, a second PRS 308b, third PRS 308 received from the mobile access node 310 at a first time instance t0 using the first measurement configuration 304. The WTRU 302 may determine the distance 312a between the WTRU 302 and the mobile access node 310 based on the first measurement of the first PRS 308a. If the determined distance 312a is less than the first distance threshold, the WTRU 302 may perform a second measurement of a second PRS 308b (e.g., at a second time instance t1) using the first measurement configuration 304. If the determined distance 312a is greater than the first threshold but less than or equal to the second distance threshold, the WTRU 302 may select the second measurement configuration 306 and/or perform a second measurement of a fourth PRS 308d using second measurement configuration 306. If the determined distance 312b is greater than the second threshold, the WTRU 302 may select an alternative access node for performing PRS measurements.

The WTRU 302 may transmit to the network a measurement report. The measurement report may include the first and second PRS measurements (e.g., RSRP, RSTD, possibly along with timestamps indicating when the measurements are made), information on the access nodes (e.g., fixed and mobile) used for positioning (e.g., IDs), and/or information on the measurement configurations used by the WTRU 302 (e.g., IDs and timestamps indicating the time when selecting/switching between the different measurement configurations).

A WTRU 302 may determine whether to use a first measurement configuration 304 (e.g., high periodicity, short duration) or a second measurement configuration 306 (e.g., low periodicity, long duration) for measuring PRS 308 received from the mobile access node 310 (e.g., drone, satellite) based on the relative distance of the WTRU 302 with respect to the access node.

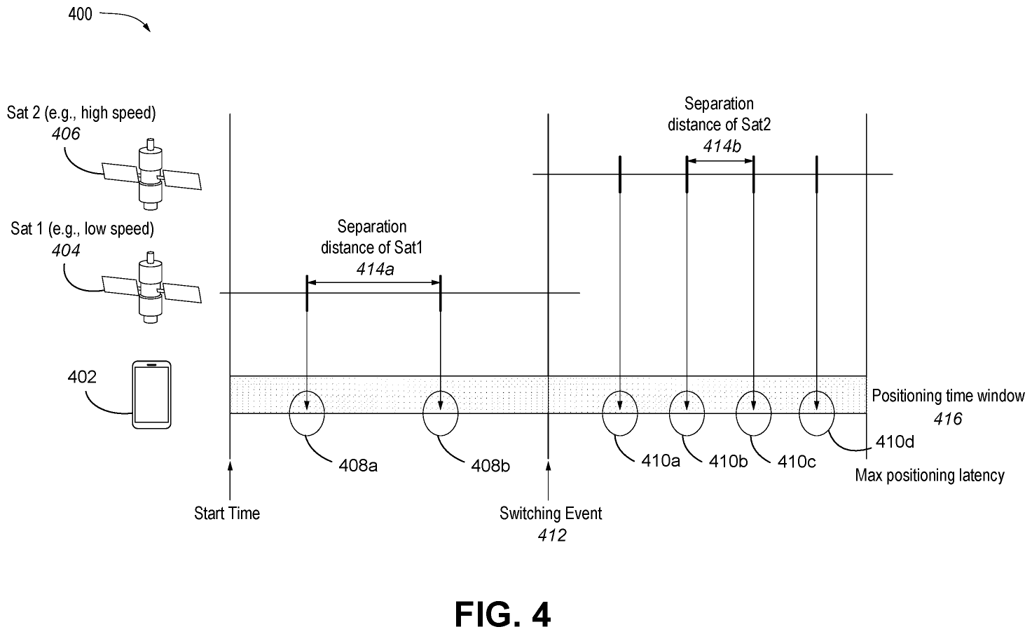

FIG. 4 depicts an example scenario 400 of switching from using a first satellite 404 to a second satellite 406. In examples, a WTRU 402 may switch between using different satellites 404, 406 for meeting positioning QoS requirements (e.g., accuracy, latency) based on the detection of a switching event 412 (e.g., low RSRP indicating poor link quality between WTRU and satellite). In this case, the switching between mobile satellites 404, 406 and/or reconfiguring the measurement configuration may be done such that any additional latency and/or overhead due to switching is minimized. An example procedure applied by the WTRU 402 for switching between different satellites 404, 406 for meeting positioning QoS may include one or more of the following.

The WTRU 402 may receive configuration information from the network. The configuration information may include ephemeris data (e.g., trajectory, speed, location) associated with one or more satellites (e.g., such as satellite 404 and satellite 406), one or more PRS configurations associated with one or more satellites, separation criteria (e.g., minimum spatial separation between two satellites, or minimum spatial separation 414a, 414b of a single satellite between two time instances), a positioning time window 416 (e.g., start time, maximum latency for PRS measurements, minimum number of measurement time instances), and/or an RSRP threshold (e.g., used for detecting a switching event where the WTRU 402 may switch to another satellite for positioning).

The WTRU 402 may select a first satellite 404 and may determine its associated measurement time instances 408a, 408b. The measurement time instances 408a, 408b for the selected first satellite 404 may be determined based on ephemeris data, separation criteria (e.g., such as the separation distance 414a of the first satellite 404), and/or the positioning time window 416, for example. The WTRU 402 may select a satellite (e.g., such as the first satellite 404) whose measurement time instances (e.g., measurement time instances 408a, 408b) may overlap with the positioning time window 416 and whose time instances may occur at the earliest, for example.

The WTRU 402 may perform measurements (e.g., RSRP) of PRS received from the first satellite 404 at its one or more measurement time instances 408a, 408b after the start time of positioning. The measurement time instances 408a, 408b may be separated by a separation distance 414a associated with the first satellite 404. If a switching event 412 is detected (e.g., RSRP of measurement is below the RSRP threshold), the WTRU 402 may select a second satellite 406 and determine one or more measurement time instances 410a, 410b, 410c, 410d associated with the second satellite 406. The measurement time instances 410a, 410b, 410c, 410d for the second satellite 406 may be determined based on ephemeris data, separation criteria (e.g., such as the separation distance 414b of the second satellite 406), and/or the positioning time window 416, for example. The WTRU 402 may perform measurements (e.g., RSRP) of PRS received from the second satellite 406 at its one or more measurement time instances 410a, 410b, 410c, 410d after switching to the second satellite 406.

The WTRU 402 may transmit a measurement report to the network. The measurement report may include PRS measurements (e.g., RSRP, possibly along with timestamps) and/or satellite information (e.g., IDs, possibly along with timestamps indicating the switching time from first satellite 404 to the second satellite 406).

A WTRU 402 may switch from using the first satellite 404 to the second satellite 406, for example, to meet one or more positioning QoS requirements (e.g., such as accuracy, latency, etc.) based on the detection of a switching event 412.

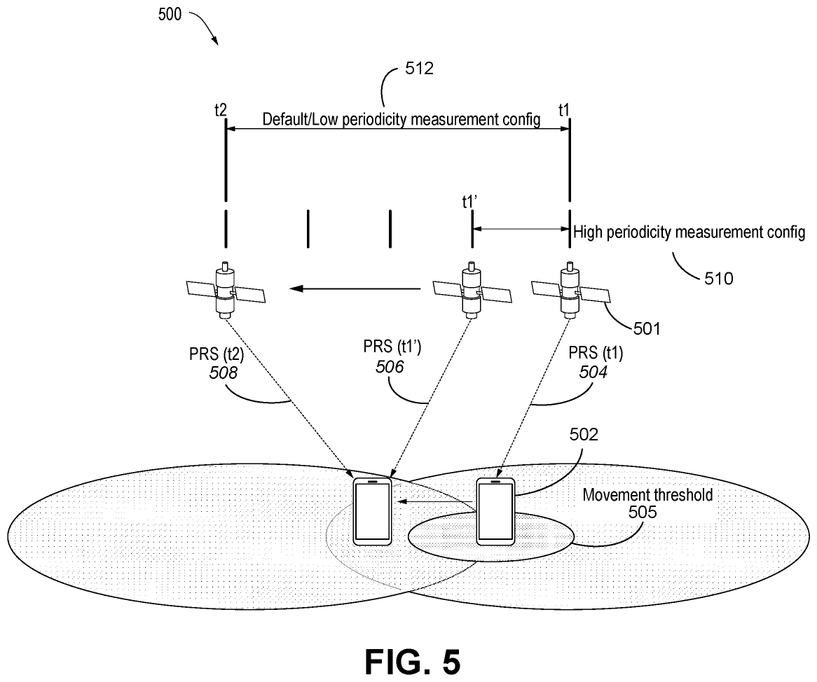

FIG. 5 depicts an example scenario 500 where a measurement configuration is determined based on relative movement of a WTRU 502 with respect to a movement threshold. In examples, a WTRU 502 may determine a measurement configuration 510, 512, including a set of measurement time instances t1, t1′, t2, to use when performing measurement of PRS 504, 506, 508 received from a mobile satellite 501 based on the relative movement of the WTRU 502. An example procedure applied by the WTRU 502 to determine the measurement configuration considering the relative WTRU movement may include one or more of the following.

A WTRU 502 may receive configuration information (e.g., info) from the network. The configuration information may include a first measurement configuration 510, a second measurement configuration 512 (e.g., IDs), and/or a movement threshold 505 (e.g., used for determining the amount of change in RSRP and/or ToA measurements over different time instances). The first measurement configuration 510 may include a set of time instances t1″ with high periodicity, for example. The first measurement configuration 510 may be used when the relative movement of the WTRU 502 is low (e.g., determined with respect to change in ToA and RSRP measurements of PRS over different time instances). The second measurement configuration 512 may include a set of time instances t1, t2 with low periodicity, for example. The second measurement configuration 512 may be used when the relative movement of the WTRU 502 is high, for example.

The WTRU 502 may perform a set of first and second measurements (e.g., RSRP, ToA) of a PRS 504, 508 received from the satellite 501 using the second measurement configuration 512. If the difference between first and second measurements is less than the movement threshold 505, the WTRU 502 may perform a third measurement of the PRS (e.g., RSRP, ToA) using the first measurement configuration 510 at next time instance, t1′. If the difference between first and second measurements is greater than or equal to the movement threshold 505, the WTRU 502 may perform a third measurement of PRS (e.g., RSRP, ToA) using the second measurement configuration 512 at a next time instance, t2.

The WTRU 502 may transmit a measurement report to the network. The measurement report may include a first PRS measurement, a second PRS measurement, a third PRS measurement, information on the access nodes (e.g., fixed and mobile) used for positioning (e.g., IDs), and/or one or more measurement configurations 510, 512 used by the WTRU 505 (e.g., IDs and timestamps indicating the time when selecting/switching between the different measurement configurations). The first, second and third PRS measurements may include RSRP, ToA, and/or timestamps indicating when the measurements are made.

A WTRU 502 may determine the measurement configuration 510, 512 (e.g., set of measurement time instances over a time duration), performing measurement of one or more PRSs 504, 506, 508 (e.g., received from a mobile satellite 501 based on the relative movement of the WTRU 502 with respect to a movement threshold 505). The WTRU 502 may switch from using a high periodicity measurement configuration 510 to a low periodicity measurement configuration 512 when the movement of the WTRU 502 (e.g., determined based on amount of change in the PRS measurements) is below the movement threshold 505.

In examples, the location information of a WTRU may be determined in scenarios where one or more of the access nodes are mobile when using any of UL-based positioning approaches (e.g., UL-TDoA, UL-AoA). The location of the WTRU may be determined based on the UL signals (e.g., SRSp) transmitted by the WTRU and/or measurements made by network nodes/entities at one or more access nodes and/or satellites (e.g., mobile and stationary) and/or terrestrial/ground-based base stations gNBs, TRPs, relay nodes and PRUs. Since the location of the WTRU may be determined based on measurements of UL signals made at network, any security issues possibly due to potential exposure of the WTRU location to eavesdropping entities during initial access or during transmission of WTRU location info may be mitigated.

The “UL signals”, described herein, may include one or more SRS or SRSp (SRS for positioning) transmissions which may be performed by WTRU using any of SRS/SRSp resources, resource sets, beams, frequency layers and configurations. The “UL signals”, described herein, may include one or more RACH preambles, sequences, partitions and resources, which may be possibly transmitted by WTRU during any of the RACH occasions.

For transmitting UL signals for positioning (e.g., SRSp, RACH preambles), the WTRU may use resources and/or configurations that may be received from the network (e.g., gNB, LMF) and/or access nodes/TRPs/satellites. For ensuring that the access nodes may accurately and reliably perform measurements of UL signals and subsequently determine the location of WTRU (e.g., at gNB, LMF), the WTRU may apply certain adjustments/corrections to the UL signals according to the estimated/indicated TA value (e.g., differential TA, WTRU-specific TA), for example. In the case when initial access messages/signals are used for UL-based positioning the WTRU may explicitly or implicitly initiate the measurements at TRPs by transmitting initial access messages, for example. The measurement reports including the measurements made by the access nodes/satellites/TRPs may be forwarded to an anchor base station, gNB, BBU or CU in RAN or to the AMF or LMF for determining the WTRU location.

When the WTRU is configured with timing-based methods (e.g., UL-TDoA) for UL-based positioning, the ToA, RTOA, RSTD and/or RSRP measurements made by a mobile access node/satellite at different time instances can be used to estimate the distances between WTRU and the access mode/satellite. The estimated distances between WTRU and mobile access node at different time instances may be used for calculating the WTRU location, for example.

When the WTRU is configured with angle-based methods (e.g., UL-AoD) for UL-based positioning, the RSRP of the Tx beam transmitted by WTRU at different time instances corresponding to the trajectory of the mobile access node is used to estimate the distances between the WTRU and the access node. The WTRU may use the same/fixed or different Tx beam based on knowledge of the trajectory/orientation of the access node/satellite, for example.

Determining the WTRU location with UL-based positioning during initial access may include one or more of the following. For example, the WTRU location may be determined using transmission and/or measurement of SRSp/SRS and/or transmission and/or measurement of RACH signals or initial access messages.

For example, the WTRU may transmit SRSp or SRS at one or more time instances which may be received and measured by the one or more access nodes. The time instances for SRSp transmission may be preconfigured in WTRU and/or determined by WTRU based on the trajectory/ephemeris info of the mobile access node/satellite and separation criteria, for example.

When performing transmissions of SRSp, the WTRU may perform certain adjustments/corrections/offsets to the SRSp resources/signals based on the estimated TA value (e.g., differential TA+common TA), for example.

The location of the WTRU may be determined (e.g., at network) based on any of RTOA, RSRP, RSTD, and AoA measurements made by the one or more access nodes, for example.

In examples, the WTRU may transmit RACH preambles which may be received and measured by one or more access nodes. The measurements made on the RACH preambles by the access nodes, may include RTOA, RSRP, RSTD, AoA, AOD, degree of correlation with known preambles/sequences, etc.

In examples, the WTRU may transmit RACH preambles at the RACH occasions dedicated for requesting msg2 which may include positioning related configurations (e.g., SRSp configurations). The RACH occasions dedicated for positioning or for requesting msg2, including positioning configurations, may be broadcasted by the network (e.g., in SIB/SSB) or preconfigured in WTRU in RRC_CONNECTED and/or via RRC_Release message, for example.

In examples, the WTRU may transmit RACH preambles or other initial access messages in subsequent UL-transmissions (e.g., during or after initial access) intended for positioning. For example, the WTRU may perform first transmission of RACH preambles (e.g., in Msg1, MsgA) for initial access and/or for initiating positioning, and a second transmission of RACH preambles (e.g., in Msg 2 or beyond) for UL-based positioning. When performing first and/or second transmission of RACH preambles, the WTRU may perform certain adjustments/corrections/offsets to the RACH preambles based on the estimated TA value (e.g., differential TA+common TA), for example.

For performing UL-based positioning using mobile access nodes, the information/indications received by WTRU may include one or more SRSp resources/configurations/parameters. For example, the SRSp resources/configurations may be associated with a mobile access node/satellite or associated with the trajectory followed by the access node.

For performing UL-based positioning using mobile access nodes, the information/indications received by WTRU may include access node/satellite info, including IDs, trajectory info, mobility attributes (e.g., speed, direction), and/or separation criteria. For performing UL-based positioning using mobile access nodes, the information/indications received by WTRU may include measurement/transmission time instances for transmitting SRSp. For performing UL-based positioning using mobile access nodes, the information/indications received by WTRU may include TA information, including common/cell/beam-specific TA, and/or assistance data for estimating differential/WTRU-specific TA. For performing UL-based positioning using mobile access nodes, the information/indications received by WTRU may include reference points associated with the common/cell/beam-specific TA, including location information (e.g., coordinates) of the reference points. For performing UL-based positioning using mobile access nodes, the information/indications received by WTRU may include parameters/threshold values (e.g., distance from reference points) associated with positioning.

Similarly, the messages/indications transmitted by the WTRU for supporting UL-based positioning may include a request for configurations or activation/deactivation of one or more preconfigured SRSp resources/configurations/parameters and/or a request for assistance data associated with an access node/satellite (e.g., trajectory info, mobility attributes, transmission time instances, separation criteria).

Any of the indications, signaling (e.g., control and data), messages and configurations (e.g., SRSp resources/configurations) may be transmitted and/or received by WTRU in broadcast signaling. RRC signaling, LPP signaling, a MAC CE, and/or L1 channels/signaling.

For example, a WTRU may access/acquire information for performing positioning during and/or after initial access via any of SIB, posSIB, and/or SSB.

For example, the WTRU may transmit/receive any of the request messages, response messages, and configurations associated with positioning and/or initial access via RRC messages.

For example, the WTRU may transmit/receive any LPP messages by using any of the identifiers associated with LPP (e.g., LPP session ID, LMF ID, WTRU ID, access node/satellite ID).

For example, the WTRU may transmit/receive any of the request messages, response messages, configurations, activation/deactivation indications associated with positioning in one or more MAC CEs. In UL, the MAC CEs, possibly carrying any of request or response messages, may be multiplexed in PUSCH (e.g., when transmitting Msg 2, Msg A), for example. Similarly, in DL, the MAC CEs may be multiplexed in PDSCH (e.g., when receiving Msg 4, Msg B), for example.

The L1 channels/signaling may include UCI (e.g., PUCCH) or DCI (e.g., PDCCH).

In examples, the WTRU may receive the SRSp configurations to use from the network (e.g., LMF) or a fixed/stationary access node (e.g., gNB, TRP). In this case, the fixed access node may operate as an anchor access node (e.g., RRC/LPP/NRPPa anchor) that may coordinate the WTRU (e.g., for triggering SRSp transmissions) and/or the mobile access nodes (e.g., for measuring the SRSp). In examples, where the anchor access node may be mobile, the WTRU may receive any of the new or updated SRSp configurations from the mobile access node.

The SRSp configurations received by WTRU may indicate the association between the mobile access nodes and the SRSp. For example, the SRSp configurations may include the IDs of the mobile access nodes that are expected to measure the SRSp transmitted by the WTRU at different configured time instances associated with the SRSp configurations. The WTRU may use an SRSp configuration based on the detection of the mobile access node (e.g., ID) so that the SRSp transmitted by the WTRU at different time instances can be measured the mobile access node, for example.

Similarly, SRSp configurations may indicate the association between the SRSp and the trajectory that one or more access nodes are expected to follow, for example. In this case, the WTRU may use a preconfigured SRSp configuration based on the detection/estimation of the trajectory (e.g., ID) of one or more access nodes so that the SRSp transmitted by the WTRU can be measured by any of the mobile access nodes following the trajectory, for example.

In examples, the WTRU may receive the activation/deactivation indications indicating the transmission of one or more types of preconfigured SRSp (e.g., periodic SRSp, aperiodic SRSp, semi-persistent SRSp). Such indications may be received by WTRU from the network (e.g., LMF), fixed/stationary access node (e.g., gNB, TRP) or from the mobile access node/satellite, for example. Such indications may be received via RRC signaling, MAC CE or DCI, for example. In examples, the WTRU may autonomously determine the activation/deactivation of SRSp transmission based on preconfigured assistance data (e.g., transmission time instances, trajectory info, separation criteria) and/detection of one or more events (e.g., measurement events, estimation events, mobility events).

The WTRU may determine the SRSp parameters for UL-based positioning using mobile access nodes.

In examples, a WTRU may be configured with one or more UL-based positioning approaches (e.g., UL-TDoA, UL-AoD) based on transmission of UL signals (SRSp) to one or more mobile access nodes. For determining when to perform SRSp transmissions to a mobile access node, the WTRU may be configured with separation criteria (described in another section of this disclosure) and/or a set of transmission time instances. The separation criteria may indicate the minimum distance or spatial separation of a mobile access node (e.g., following a trajectory, speed and direction) between at least two time instances used by the WTRU for performing SRSp transmissions, for example. The SRSp transmission time instances may correspond to the separation criteria associated with a mobile access node/satellite selected for positioning and/or performing SRSp measurements, for example,

In examples, the WTRU may be indicated/configured to use one or more of mobile access nodes (e.g., IDs) for UL-based positioning. Such configurations, possibly along with the SRSp configurations and other assistance data (e.g., trajectory info, transmission time instances, TA values) may be received by WTRU via LPP or AS-layer signaling (e.g., RRC messages). In examples, the WTRU may determine/select to use one or more mobile access nodes for UL-based positioning. The WTRU may send an indication to network and/or the selected access node to request for the configuration info for positioning (e.g., SRSp configurations, trajectory info). The WTRU may then perform SRSp transmissions at different time instances based on the configuration info received from network/access node, for example.

In examples, the WTRU may determine the transmission time instances based on the received configuration information and/or other events detectable at the WTRU, for example. Such events may include measurement events (e.g., RSRP of a DL signal such as SSB or PRS, which may be associated with or in spatial relation with the UL SRSp, is below a threshold value), estimation events (e.g., the estimated differential TA is above a TA threshold) or mobility events (e.g., change in mobility attributes such as speed or direction of access node or WTRU), for example. In this case, the WTRU may determine the transmission time instances based on the separation criteria, possibly by spacing out the SRSp transmissions with a periodicity value aligned with the separation criteria or trajectory of the access node, for example.

In examples, the WTRU may determine the repetition factor to use when transmitting SRSp based on the detection of any events. For example, when detecting a measurement or estimation event, the WTRU may increase the repetition factor, possibly when transmitting SRSp in one or more transmission time instances. The WTRU may then fall back to using a default repetition factor when any of the events are no longer detectable or active, for example.

In examples, the WTRU may update other parameters associated with SRSp, including the transmission time instances, number of resources/resource sets, periodicity, repetition factor, Tx power, and TA value based on the mobility attributes of the access node/satellite, changes to trajectory and changes to radio link conditions. For example, when selecting an access node/satellite whose distance or altitude from the WTRU is greater than a threshold value, the WTRU may use a higher Tx power compared to a default Tx power value. Similarly, when using a slow-moving satellite, the WTRU may increase the periodicity associated with the transmission time instances or may increase the repetition factor while maintaining the periodicity, for example. The parameters that may be allowed to be updated by the WTRU may be preconfigured in the WTRU or determined by the WTRU based on detections of any events, for example. When updating the SRSp parameters, the WTRU may send an explicit or implicit indication to the associated access node/satellite and/or network, for example.

In examples, associated with UL-RTOA measurements when performing SRSp transmissions to mobile access node, the WTRU may be configured with a synchronization source (e.g., GNSS satellite, geostationary satellite, gNB) from which the WTRU may determine the absolute time. In this case, the first SRSp transmission performed by the WTRU to a mobile access node at an absolute time value may be used as the reference time, possibly for determining/calibrating the transmission time instances/windows. The subsequent time instances at which the WTRU performs SRSp repetitions or new SRSp transmissions to the same mobile access node may be used for determining the RTOA measurements with respect to the first SRSp transmission, for example.

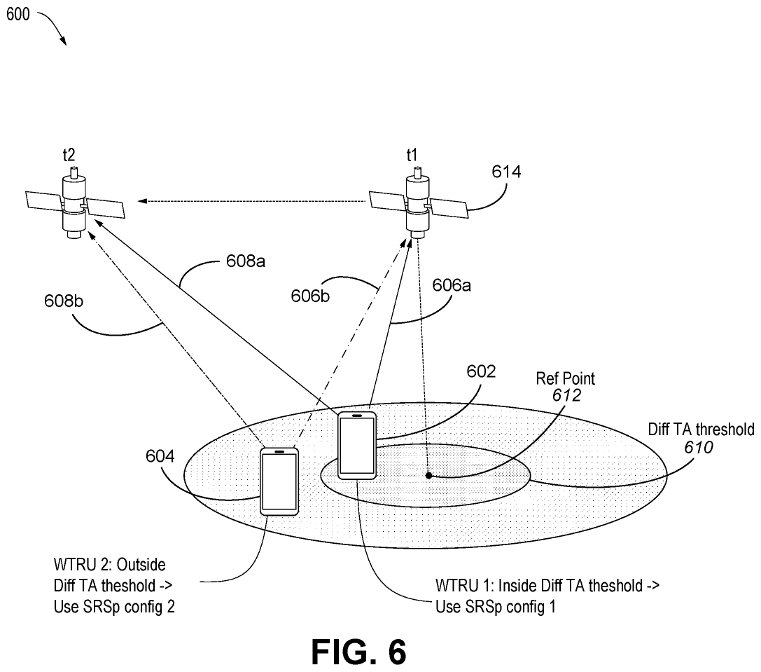

FIG. 6 depicts an example scenario 600 for selection of an SRSp configuration for UL-based positioning with a mobile satellite 614. In examples, a WTRU 602, 604 may select the SRSp configuration (e.g., SRSp resources transmission power, periodicity, repetition factor) to use for UL-based positioning with a mobile satellite 614 based on determination of differential TA (e.g., difference between TA at WTRU 602, 604 and TA at reference point 612) and relative location of WTRU 602, 604 with respect to the mobile satellite 614. An example procedure applied by WTRU 602, 604 for performing UL-based positioning with the mobile satellite 614 may include one or more of the following.

The WTRU 602, 604 may receive configuration info from the network (e.g., gNB, LMF). The configuration information may include a first SRSp configuration (e.g., including resources with low repetition factor) and a second SRSp configuration (e.g., including resources with high repetition factor). The first SRSp configuration may be used when the WTRU 602, 604 may be located close (e.g., within a predefined location threshold) to the reference point 612 on the cell associated with the mobile satellite 614 or when experiencing better link condition (e.g., link between WTRU 602, 604 and satellite 614), for example. The second SRSp configuration may be used when the WTRU 602, 604 may be located far (e.g., beyond a predefined location threshold) from the reference point 612 on the cell or when experiencing poor radio link condition, for example.

The configuration information may include a set of transmission time instances t1, t2 associated with first SRSp configuration and/or second SRSp configuration.

The configuration information may include assistance data for calculating differential TA (e.g., including a set of common/cell-specific TA values associated with different transmission time instances). The configuration information may include a differential TA threshold 610 for positioning. The differential TA threshold 610 may be used for determining whether the WTRU 602, 604 is located in proximity to the reference point 612 center or far from the reference point 612.

The WTRU 602, 604 may determine differential TA based on the received assistance data (e.g., common TA). In examples, the WTRU 602, 604 may determine the differential TA based on initial positioning info of the WTRU 602, 604 (e.g., determined via GNSS). If the determined differential TA is less than the differential TA threshold 610, the WTRU 602, 604 may select the first SRSp configuration (e.g., low repetition factor). If the determined differential TA is greater than or equal to the differential TA threshold 610, the WTRU 602, 604 may select the second SRSp configuration (e.g., high repetition factor).

The WTRU 602, 604 may send an indication to the network (e.g., gNB) or to the satellite, requesting to activate the selected SRSp configuration, for example. The WTRU 602, 604 may transmit the SRSp 606a, 606b, 608a, 608b upon applying an overall TA offset/compensation value (e.g., overall TA is a function of the differential TA and common TA) to the SRSp 606a, 606b, 608a, 608b at the associated transmission time instances t1, t2. The WTRU may transmit SRSp 606a, 606b, 608a, 608b, upon receiving an activation indication from network or satellite 614, for example.

The WTRU 602, 604 may repeat the above sequence for performing UL-based positioning with mobile satellite 614 at the next SRSp transmission time instance, for example.

A WTRU 602, 604 may select a first SRSp configuration or a second SRSp configuration for UL-based positioning with a mobile satellite 614 based on determination of a differential TA (e.g., with respect to TA associated with reference point 612) and/or a relative location of the WTRU 602, 604 with respect to the mobile satellite 614. When a first WTRU 602 (e.g., WTRU1) is within an area indicated by the differential TA threshold 610, the first WTRU 602 may transmit a first SRSp 606a, 606b to the mobile satellite 614 using the first SRSp configuration at respective transmission time instances of t1 and t2. When a second WTRU 604 (e.g., WTRU2) is outside of the area indicated by the differential TA threshold 610, the second WTRU 604 may transmit a second SRSp 608a, 608b to the mobile satellite 614 using the second SRSp configuration at respective transmission time instances of t1 and t2.

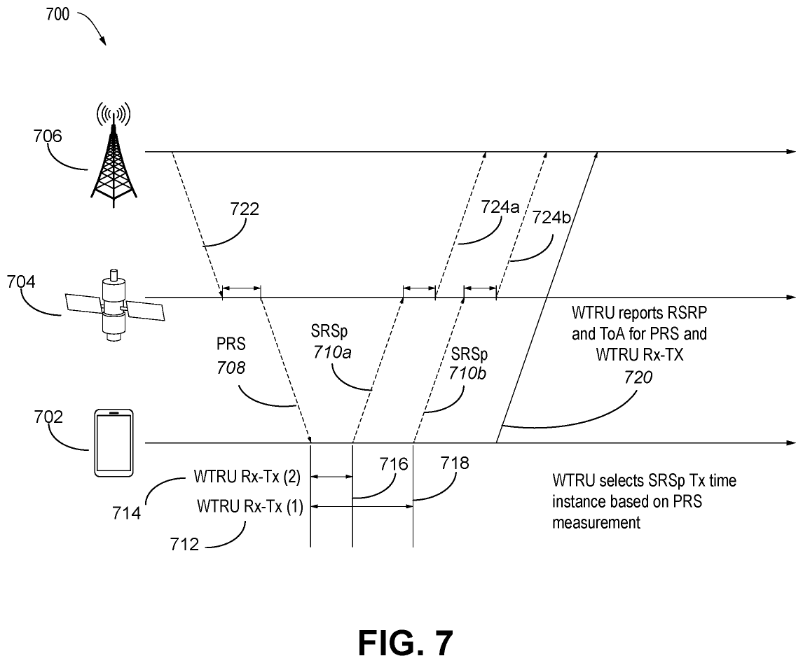

FIG. 7 depicts an example scenario 700 of RTT measurement configuration selection. In examples, a WTRU 702 may select the round-trip time (RTT) measurement configuration 712, 714 to use for measuring PRS 708 and transmitting SRSp 710a, 710b from/to a mobile satellite 704 based on the determination of the radio link quality between the WTRU 702 and satellite 704. For RTT-based positioning, using the same Rx-Tx configuration (e.g., timing for PRS reception and SRSp transmission) irrespective of the relative WTRU location with respect to a mobile satellite 704 may result in low positioning accuracy. An example procedure that may be applied by the WTRU 702 for selecting a suitable RTT measurement configuration 712, 714 based on the determination of the link quality between the WTRU 702 and the mobile satellite 714 may include one or more of the following.

The WTRU 702 may receive configuration information from the network 706 (e.g., gNB and/or LMF). The configuration information may include multi-RTT configurations (e.g., including one or more PRS configurations, and SRSp configurations), a first RTT measurement configuration 712 (e.g., including long separation duration between PRS measurement and SRSp transmission), a second RTT measurement configuration 714 (e.g., including short separation duration between PRS measurement and SRSp transmission), and/or an RSRP threshold. The RTT measurement configurations 712, 714 may be indicated with IDs and/or may include a set of time instances indicating the time slot/occasion for PRS reception/measurement and SRSp transmission. The first RTT measurement configuration 712 may be used by the WTRU 702 when the quality of link between the WTRU 702 and the satellite 704 is good (e.g., high RSRP) and the second RTT measurement configuration 714 may be used by the WTRU 702 when the quality of link between the WTRU 702 and the satellite 704 is poor, for example. The RSRP threshold may be used for determining the quality of a link between the WTRU 702 and the satellite 704.

The WTRU 702 may initially select the first RTT measurement configuration 712 and/or may perform measurement (e.g., RSRP) of PRS 708 received from the satellite 704 at the first time instance 716 associated with the first RTT measurement configuration 712. Such measurement of the PRS 708 or any other DL signal (e.g., SSB) received from the satellite 704 may be made by the WTRU 702 for determining the radio link quality (e.g., RSRP) between the WTRU 702 and the satellite 704, for example.

If measured RSRP is less than an RSRP threshold, the WTRU 702 may transmit SRSp 710b using resources in SRSp configuration at the next time instance 718 associated with the first RTT measurement configuration 712. For example, the WTRU 702 may transmit SRSp 710b using a longer/default separation duration after PRS measurement if the PRS measurement indicates good link quality (e.g., link quality greater than a predetermined threshold).

If measured RSRP is greater than or equal to the RSRP threshold, the WTRU 702 may select the second RTT measurement configuration 714. The WTRU 702 may transmit SRSp 710a using resources in SRSp configuration at the next time instance 716 associated with the second RTT measurement configuration 714. For example, the WTRU 702 may transmit SRSp 710a using a shorter separation duration (e.g., fast SRS transmission) after PRS measurement, if the PRS measurement indicate poor link quality (e.g., link quality below the predetermined threshold).

The WTRU 702 may measure the Rx-Tx time difference based on the selected RTT measurement configuration 712, 714 used and the separation time duration between PRS measurement and SRSp transmission.

The WTRU 702 may transmit a measurement report 720 to the network 706 (e.g., LMF). The measurement report 720 may include one or more PRS measurements (e.g., RSRP, possibly along with timestamps indicating when the measurements are made), one or more WTRU Rx-Tx measurements, information on the access nodes (e.g., fixed and mobile) used for positioning (e.g., IDs), and/or RTT measurement configuration info (e.g., IDs and timestamps indicating the time when selecting/switching between the different preconfigured RTT configurations).

A WTRU 702 may select the RTT measurement configuration to use (e.g., corresponding to WTRU Rx-Tx(1) 712 or WTRU Rx-Tx(2) 714 for measuring PRS 708 and transmitting SRSp 710a, 710b from/to a mobile satellite 704 based on the determination of the radio link quality (e.g., RSRP measurement) between the WTRU 702 and the satellite 704. Base station 706 may send the mobile satellite 704 its own PRS signal. And mobile satellite 704 may send the base station 706 SRSp signals 710a,b. The base station 706 may send PRS 708 to the mobile satellite 704 or another signal 722 (e.g. different than PRS) that may trigger transmission of PRS 708 from the mobile satellite 704 to WTRU 702. The mobile satellite 704 may send to the base station 706 SRSp signals 710a,b received from WTRU 702 or transmit one or more other signals 724a,b (different than SRSp) to the base station 706 upon reception of SRSp 710a,b from WTRU 702. The WTRU 702 may receive, from mobile satellite 704, configuration information indicating a plurality of sets of associations. Each set of associations may comprise a plurality of respective time instances and a plurality of respective timing advance (TA) offsets. The WTRU 702 may transmit, to satellite 704, an indication of at least one of a mobile network node identification or WTRU location information. The WTRU 702 may receive an indication, from satellite 704, of a first set of associations of the plurality of sets of associations. The first set of associations may comprise one or more sets of WTRU TA offsets and/or satellite TA offsets. The WTRU 702 may transmit, to satellite 704, a first sounding reference signal for positioning (SRSp) transmission 710a beginning at a first time 716. The first time 716 may be determined based on at least a first TA offset of the first set of associations and a first time instance associated with the first TA offset.

The WTRU 702 may transmit the first SRSp transmission 710a to satellite 704 corresponding to the mobile network node identification or the WTRU location information. The first time 716 may be prior to the first time instance by a first TA value. The first TA value may be determined based on the first TA offset. The first TA value may be determined based on a sum of the first TA offset and a first WTRU TA offset. The first WTRU TA offset may be determined (by the WTRU, satellite, and/or base station) based on a first location of the WTRU (e.g., or based on a first location with respect to the satellite 704). The first TA offset may be selected from the first set of associations based on a resource used for the first SRSp transmission 710a being associated with the first time instance. The first TA offset may be selected based on an area in which the WTRU 702 and/or the satellite 704 is located. The configuration information may comprise a set of SRSp resources. The first SRSp transmission 710a may be transmitted using at least one resource of the set of SRSp resources.

The WTRU 702 may receive an indication of a second set of associations of the plurality of sets of associations. The WTRU 702 may transmit a second sounding reference signal for positioning (SRSp) transmission 710b beginning at a second time 718. The second time 718 may be determined based on at least a second TA offset of the second set of associations and a second time instance associated with the second TA offset. The second time 718 may be prior to the second time instance by a second TA value. The second TA value may be determined based on the second TA offset. The second TA value may be determined based on a sum of the second TA offset and a second WTRU TA offset. The second WTRU TA offset may be determined based on a second location of the WTRU 702 or the first location of the WTRU 702.

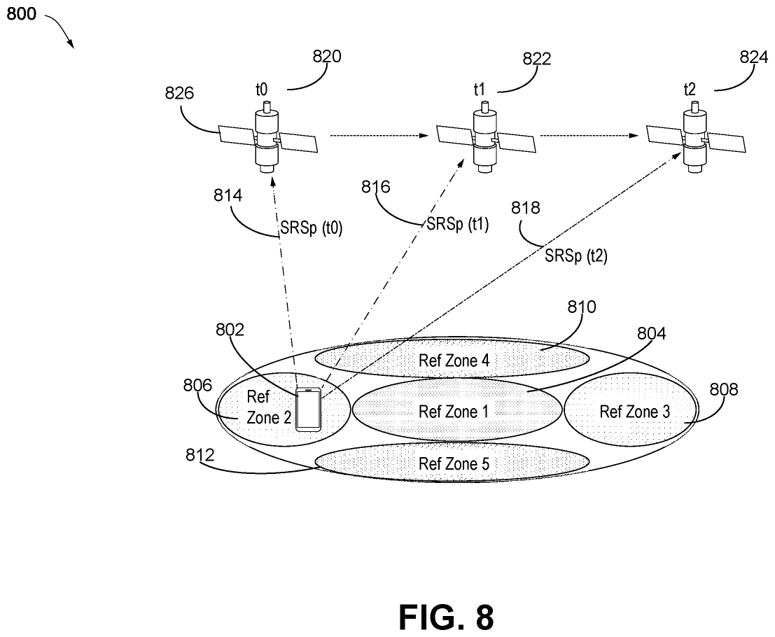

FIG. 8 depicts another example selection 800 of a sounding reference signal (SRS) for positioning (SRSp) configuration for uplink-based positioning with a mobile satellite 826. WTRU 802 may be located in any one of the following reference zones: ref zone 1 804, ref zone 2 806, ref zone 3 808, ref zone 4 810, and ref zone 5 812. As shown in FIG. 8, WTRU 802 may be located in ref zone 2 806. The WTRU 802 may receive configuration information, from satellite 826, indicating a plurality of sets of associations. Each set of associations may comprise a plurality of respective time instances and a plurality of respective timing advance (TA) offsets. The WTRU 802 may transmit, to satellite 826, an indication of at least one of a mobile network node identification or WTRU location information. The WTRU 802 may receive an indication, from satellite 826, of a first set of associations of the plurality of sets of associations. The WTRU 702 may transmit, to satellite 826, a first sounding reference signal for positioning (SRSp) 814 transmission beginning at a first time (e.g., t0 820). The first time (e.g., t0 820) may be determined based on at least a first TA offset of the first set of associations and a first time instance associated with the first TA offset.

The TA offset may be any number (e.g., 0, positive, and/or negative). The TA offset may be determined based on the satellite's position with respect to the WTRU's position. As the satellite moves closer to the WTRU, the TA offset may decrease. As the satellite moves away from the WTRU, the TA offset may increase. The TA offset may decrease then increase in some examples (e.g. 0 ms [starting TA offset with satellite on left side of WTRU], −1 ms [satellite moving to the right closer to WTRU], −2 ms, −3 ms [satellite directly over/closest to WTRU], −2 ms [satellite moving away from WTRU to the right], −1 ms, 0 ms [satellite on opposite side of WTRU starting point], 1 ms, 2 ms, 3 ms, 4 ms, etc.). The TA offset may only increase in some examples, (e.g. 0 ms [starting TA offset], 1 ms [satellite moving away from WTRU], 2 ms, 3 ms, 4 ms, etc.).

The WTRU 802 may receive an indication of a second set of associations of the plurality of sets of associations. The WTRU 802 may transmit, to satellite 826, a second sounding reference signal for positioning (SRSp) 816 transmission beginning at a second time (e.g., t1 822). The second time 822 may be determined based on at least a second TA offset of the second set of associations and a second time instance associated with the second TA offset. The second time 822 may be prior to the second time instance by a second TA value. The second TA value may be determined based on the second TA offset. The second TA value may be determined based on a sum of the second TA offset and a second WTRU TA offset. The second WTRU TA offset may be determined based on a second location of the WTRU (e.g., ref zone 1 804, ref zone 3 808, ref zone 4 810, and/or ref zone 5 812) or the first location of the WTRU (e.g., ref zone 2 806). WTRU 802 may transmit, to satellite 824, a third SRSp 818 at a third time 824.

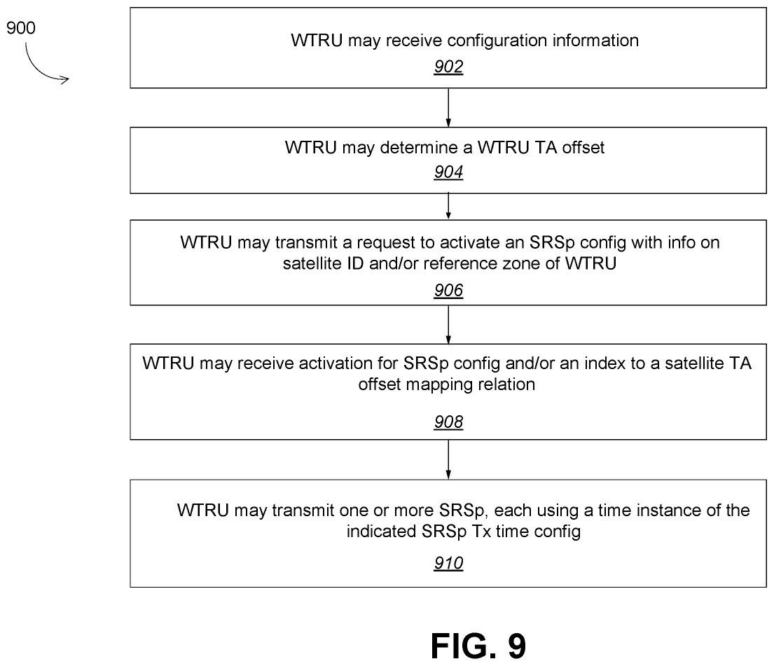

FIG. 9 depicts a process 900 for transmitting uplink SRSp with timing advances (TAs).

At 902, a WTRU (e.g., such as the WTRU 102a, 102b, 102c, 102d shown in FIG. 1a, the WTRU 102 shown in FIG. 1b, the WTRU 102a, 102b, 102c shown in FIG. 1c, the WTRU 102a, 102b, 102c shown in FIG. 1d, the WTRU 202 shown in FIG. 2, the WTRU 302 shown in FIG. 3, the WTRU 402 shown in FIG. 4, the WTRU 502 shown in FIG. 5, the WTRUs 602, 604 shown in FIG. 6, the WTRU 702 shown in FIG. 7, and/or the WTRU 802 shown in FIG. 8) may receive (e.g., from LMF and/or a satellite) configuration information. The configuration information may comprise at least one SRSp configuration (e.g., set of SRSp resources), SRSp Tx time config (e.g., a set of transmission time instance values or transmission time occasions (absolute time, based on sub-frame number (SFN), symbol/slot/SFN with respect to a reference symbol/slot/SFN, etc.) allowed for WTRU transmission and/or satellite reception of SRSp, a set of satellite TA offset mapping relations (each is a mapping between satellite TA offset values and SRSp Tx time instances). At 904, the WTRU may determine a WTRU TA offset (e.g., from WTRU's zone ID and zone to TA mapping). The WTRU may determine the WTRU TA offset (base offset) for the zone of the WTRU's location (e.g., ref zone 2 of FIG. 8). At 906, the WTRU may transmit, to the network or a satellite, (e.g. in RRC message), a request to activate an SRSp configuration with information on the satellite ID and reference zone of the WTRU. At 908, the WTRU may receive activation for the requested SRSp configuration (or a new SRSp configuration), and an index to a satellite TA offset mapping relation (e.g., in the configured set).

At 910, the WTRU may transmit one or more SRSp, each using a time instance of the indicated SRSp Tx time configuration and using resources of the indicated SRSp configuration. For each time instance, the WTRU may apply a TA to the SRSp transmission that is based on (e.g., a sum of) the WTRU TA offset and a satellite TA offset value associated with the time instance according to the indicated satellite TA offset mapping relation. For example, see Table 1 below:

TABLE 1
Example Timing Advances

| SRSp Tx time instances | TA applied by WTRU |
|---|---|
| t0 | WTRU TA offset |
| t1 | WTRU TA offset + satellite TA offset1 |
| t2 | WTRU TA offset + satellite TA offset2 |

As shown above, when the WTRU transmits SRSp at time instances (e.g., at t0, t1 and t2 of FIG. 8), the WTRU may apply the WTRU TA offset (base offset) plus a satellite TA offset (a delta offset) associated with each time instance.

SRSp may be measured at different satellite locations that are sufficiently separated from each other (e.g., separated by a predetermined threshold), for example, to ensure accurate UL-based positioning.

What is claimed is:

1.-26. (canceled)

27. A wireless transmit/receive unit (WTRU) comprising:
a processor configured to:
receive configuration information for multiple round-trip time (multi-RTT) positioning from a network element, wherein the configuration information comprises a positioning reference signals (PRS) configuration and a request to report measurements related to positioning with a mobile satellite:
determine a receive (Rx) to transmit (Tx) measurement, a differential time associated with transmission time instances, and a change in time of arrival (ToA) of PRSs; and
send a report, wherein the report comprises an indication of the Rx to Tx measurement, an indication of the differential time associated with transmission time instances, and an indication of the change in ToA of PRSs.

28. The WTRU of claim 27, wherein the Rx to Tx measurement is an indication of a time difference between received PRSs and transmitted sounding reference signals (SRSs).

29. The WTRU of claim 27, wherein the processor is configured to:
send capability information associated with supporting multi-RTT positioning with a mobile satellite.

30. The WTRU of claim 29, wherein the processor is configured to:
receive a request message from a location management function (LMF); and
send the capability information based on the receiving of the request message.

31. The WTRU of claim 27, wherein the network element comprises a location management function (LMF), and wherein the report is sent to an LMF.

32. The WTRU of claim 27, wherein the processor is configured to:
receive a plurality of PRSs based on the PRS configuration; and
determine, based on the PRSs, the Rx to Tx measurement, and the differential time associated with transmission time instances.

33. The WTRU of claim 27, wherein the processor is configured to:
receive a plurality of PRSs based on the PRS configuration; and
determine, based on the PRSs and Doppler measurements over a time window, the change in ToA of PRSs.

34. The WTRU of claim 27, wherein the processor is configured to:
receive a plurality of PRSs from the mobile satellite; and
determine a reference signal time difference (RSTD) based on the plurality of PRSs received from the mobile satellite, wherein the report comprises an indication of the RSTD.

35. The WTRU of claim 27, wherein the processor is configured to:
determine the Rx to Tx measurement, the differential time associated with transmission time instances, and the change in ToA of the PRSs periodically based on a periodicity value corresponding to a measurement time window.

36. The WTRU of claim 27, wherein the processor is configured to:
receive assistance information, wherein the assistance information comprises trajectory information of the mobile satellite:
determine a time window for performing the Rx to Tx measurement, the differential time associated with transmission time instances, and the change in ToA of the PRSs based on the trajectory information.

37. A method implemented by a wireless transmit/receive unit (WTRU), the method comprising:
receiving configuration information for multiple round-trip time (multi-RTT) positioning from a network element, wherein the configuration information comprises a positioning reference signals (PRS) configuration and a request to report measurements related to positioning with a mobile satellite:
determining a receive (Rx) to transmit (Tx) measurement, a differential time associated with transmission time instances, and a change in time of arrival (ToA) of PRSs; and
sending a report, wherein the report comprises an indication of the Rx to Tx measurement, an indication of the differential time associated with transmission time instances, and an indication of the change in ToA of PRSs.

38. The method of claim 37, wherein the Rx to Tx measurement is an indication of a time difference between received PRSs and transmitted sounding reference signals (SRSs).

39. The method of claim 37, further comprising:
sending capability information associated with supporting multi-RTT positioning with a mobile satellite.

40. The method of claim 39, further comprising:
receiving a request message from a location management function (LMF); and
sending the capability information based on the receiving the request message.

41. The method of claim 37, wherein the network element comprises a location management function (LMF), and wherein the report is sent to an LMF.

42. The method of claim 37, further comprising:
receiving a plurality of PRSs based on the PRS configuration; and
determining, based on the PRSs, the Rx to Tx measurement, and the differential time associated with transmission time instances.

43. The method of claim 37, further comprising:
receiving a plurality of PRSs based on the PRS configuration; and
determining, based on the PRSs and Doppler measurements over a time window, the change in ToA of PRSs.

44. The method of claim 37, further comprising:
receiving a plurality of PRSs from the mobile satellite; and
determining a reference signal time difference (RSTD) based on the plurality of PRSs received from the mobile satellite, wherein the report comprises an indication of the RSTD.

45. The method of claim 37, further comprising:
determining the Rx to Tx measurement, the differential time associated with transmission time instances, and the change in ToA of the PRSs periodically based on a periodicity value corresponding to a measurement time window.

46. The method of claim 37, further comprising:
receiving assistance information, wherein the assistance information comprises trajectory information of the mobile satellite; and
determining a time window for performing the Rx to Tx measurement, the differential time associated with transmission time instances, and the change in ToA of the PRSs based on the trajectory information.
